(19) United States
(12) Patent Application Publication
(10) Pub. No.: US 2026/0309983 A1
(43) Pub. Date: Oct. 8, 2026

(54) OPTICAL DEVICE, ELECTRONIC DEVICE INCLUDING SAME, DISPLAY METHOD, CONTROL METHOD, AND CONTROL DEVICE

(71) Applicant: LG INNOTEK CO., LTD., Seoul (KR)

(72) Inventors: Jin Ho GWON, Seoul (KR); Min Seon GIM, Seoul (KR)

(21) Appl. No.: 18/996,737

(22) PCT Filed: Aug. 7, 2023
(86) PCT No.: PCT/KR2023/011566

§ 371 Date: Jan. 17, 2025

(30) Foreign Application Priority Data
Aug. 5, 2022 (KR) 10-2022-0097703
Aug. 5, 2022 (KR) 10-2022-0097704
Aug. 5, 2022 (KR) 10-2022-0097720
Aug. 5, 2022 (KR) 10-2022-0097721

(51) Int. Cl. G02B 27/01; G02B 27/09

(52) U.S. Cl. CPC G02B 27/0172; G02B 27/0955; G02B 2027/0178

(57) ABSTRACT

Disclosed in an embodiment is an optical device including: a plurality of lenses; a barrel in which the plurality of lenses are arranged; a first light guide disposed in the barrel; an opening formed in the side of the barrel; a light source device coupled to the opening; a through-hole formed in the side of the barrel; and a light-receiving portion arranged adjacent to the through-hole.

### CROSS-REFERENCE TO RELATED APPLICATIONS

This application is the U.S. national stage application of International Patent Application No. PCT/KR2023/011566, filed Aug. 7, 2023, which claims the benefit under 35 U.S.C. § 119 of Korean Application Nos. 10-2022-0097703, filed Aug. 5, 2022; 10-2022-0097704, filed Aug. 5, 2022; 10-2022-0097720, filed Aug. 5, 2022; and 10-2022-0097721, filed Aug. 5, 2022; the disclosures of each of which are incorporated herein by reference in their entirety.

### TECHNICAL FIELD

Embodiments disclosed herein relate to an optical device, an electronic device including the optical device, a method of display, a method of control, and a control device.

### BACKGROUND ART

Virtual Reality (VR) refers to a specific environment or situation that is created by employing an artificial technology that uses a computer or the like, and thus simulates reality without being real, or refers to this artificial technology itself.

Augmented Reality (AR) refers to a technology that superimposes a virtual object or information onto a real environment and enables the virtual object to appear as if present in the original environment.

Mixed Reality (MR) or Hybrid Reality refers to the creation of a new environment or new information by mixing a virtual world with the real world. Particularly, Mixed Reality refers to the real-time interaction between the real-time presence of an object in the real world and the real-time presence of an object in a virtual world.

At this point, a created virtual environment, situation, or the like stimulates a user's five senses and enables the user to spatially or temporally experience a virtual world similar to the real world, thereby freely blurring the border between reality and imagination. In addition, the user can not only be immersed in this situation, but also engage in mutual interaction with a virtual world, such as by performing operations or issuing commands using a device in the real world.

In recent years, research has actively been conducted on devices (or gears) used in this technology field. However, there has been an increasing demand for detecting whether the user is wearing these devices and monitoring the user's bio-signals.

In addition, these devices need to be adjusted for the user's eyesight. There has been an increasing demand for such adjustments for the user's eyesight. Moreover, there has also been an increasing demand for a simple controller for these devices. In addition, there has also been an increasing demand for these devices to be equipped with additional functionalities.

### DISCLOSURE

### Technical Problem

One object of the embodiments is to provide an optical device capable of accurately detecting a user's bio-signals using Augmented Reality (AR) or signal technologies, and an electronic device including the optical device.

Another object of the embodiments is to provide an optical device capable of reducing noise in sensing signals (bio-signals), and an electronic device including the optical device.

A further object of the embodiments is to provide an optical device capable of accurately whether or not a user is wearing an electronic device, and an electronic device including the optical device.

Another object of the embodiments is to provide an optical device capable of achieving improved electric power efficiency, and an electronic device including the optical device.

Still another object of the embodiments is to provide an electronic device capable of generating an image based on a user's eyesight, and a method of display.

Yet another object of the embodiments is to provide an electronic device capable of comfortably enabling a user to recognize a virtual image or similar content through an image selected by the user, and a method of display.

Another object of the embodiments is to provide a control device capable of reducing malfunctions by activating an input type in a manner that corresponds to a user's state, and a method of control.

A further object of the embodiments is to provide a control device capable of intuitively controlling an electronic device without drawing the attention of others, and a method of control.

Another object of the embodiments is to provide an optical device capable of easily suppressing a fogging phenomenon, and an electronic device including the optical device.

Still another object of the embodiment is to provide an optical device capable of achieving improved reliability through heat dissipation, and an electronic device including the optical device.

Yet another object of the embodiments is to provide an optical device capable of achieving improved energy efficiency, and an electronic device including the optical device.

The embodiments are not limited to the objects mentioned above, and additional objects and effects may also be identified from the means of solving the problems or from the embodiments, both the problems and the embodiments being described below.

### Technical Solution

According to one aspect of the embodiments, there is provided an optical device including: a plurality of lenses: a barrel in which the plurality of lenses are arranged; a first light guide arranged in the barrel; an opening portion formed in a lateral surface of the barrel; a light source device coupled to the opening portion; a through-hole formed in the lateral surface of the barrel; and a light reception unit arranged adjacent to the through-hole.

The optical device may include a barrier unit arranged between the through-hole and the light reception unit.

The optical device may include: an optical signal generation unit generating an optical signal including an image signal, wherein the light receiving unit may be arranged between the first light guide and the optical signal generation unit.

In the optical device, the plurality of lenses may include a first lens and a second lens that are arranged between the first light guide and the optical signal generation unit, and the first lens may have a smaller size than the second lens.

In the optical device, the light reception unit may be arranged between the first lens and the second lens.

In the optical device, the through-hole may be arranged between the first lens and the second lens.

In the optical device, the light reception unit may protrude farther than the external surface of the barrel.

In the optical device, the barrier unit may protrude farther than the external surface of the barrel.

The optical device may include: a housing in which an opening portion is formed; a second light guide arranged in the housing; and a light source emitting light toward the second light guide.

In the optical device, the light reception unit may be driven while light is emitted from the light source.

The optical device may include a control unit controlling the light source device, the optical signal generation unit, and light reception unit.

In the optical device, the control unit may receive a first light reception signal from the light reception unit in a case where electric current is not applied to the light source device.

In the optical device, the control unit may determine whether or not to drive the light source device by comparing the first light reception signal with a first setting value.

In the optical device, the control unit may drive the right source and receive a second light reception signal from the light reception unit in a case where the first light reception signal is below the first setting value.

In the optical device, the control unit may compare the second light reception signal with a second setting value and accordingly receive a third light reception signal from the light reception unit in a manner that corresponds to respective operations of the light source and the optical signal generation unit.

According to another aspect of the embodiments, there is provided an electronic device: a frame; an input unit that is arranged on the frame and outputs an input signal; an optical device arranged on the frame and generating an image; a display unit connected to the optical device and outputting the image generated by the optical device; and a control unit controlling an image signal for the image, wherein the control unit provides an image signal for a test image with a different focal distance and determines a user's eyesight based on an image selected by the input unit.

In the electronic device, the test image with a different focal distance may be adjusted by the input unit.

In the electronic device, a plurality of the test images with different focal distances may be provided and the plurality of the test images may have respective different focal distances.

In the electronic device, at least one image may be selected from among the plurality of the test images.

In the electronic device, the control may determine the user's eyesight and then adjust a focal distance for the image based on the user's determined eyesight, thereby outputting the resulting image.

In the electronic device, the control may determine the user's eyesight based on the maximum focal distance in a case where a plurality of images are selected.

In the electronic device, the control may determine the test images with different focal distances may each include a plurality of objects with different focal distances.

In the electronic device, the control may adjust a focal distance for the test image by moving a lens within the optical device.

The electronic device may include an optical element arranged on the frame, wherein the optical element may include a variable focusing lens.

In the electronic device, the control unit may change a curvature of the optical element.

According to a further aspect of the embodiments, there is provided a method of display, the method including a step of outputting test images with different focal distances; a step of determining a user's eyesight based on an image selected from among the test images with different focal distances; and a step of outputting a virtual image based on the user's determined eyesight.

The method of display may include a step of storing the user's determined eyesight after the step of determining a user's eyesight.

In the method of display, the step of determining a user's eyesight may include a step of outputting a plurality of test images with different focal distances.

In the method of display, the step of outputting a virtual image may include a step of varying a focal distance for the virtual image based on the user's determined eyesight.

In the method of display, the step of determining a user's eyesight may include: a step of selecting at least one image from among the plurality of test images with different focal distances; and a step of determining the user's determined eyesight based on the maximum focal distance in a case where a plurality of images are selected.

According to another aspect of the embodiments, there is provided a control device including: a detection unit outputting a detection signal including exercise information; and a controller, wherein the controller determines a user's state from the exercise information and determines activation of a gesture motion and a touch motion in a manner that corresponds to the user's state.

In the control device, the controller may compare whether or not the amplitude of the detection signal is above a second setting value in a case where the intensity of the detection signal is above a first setting value.

In the control device, the controller may determine the user's state as the exercise state when the amplitude of the detection signal is above the second setting value.

In the control device, the controller may compare whether or not the intensity of the detection signal is above a third setting value, when the amplitude of the detection signal is below the second setting value.

In the control device, the controller may determine the user's state as a riding state when the intensity of the detection signal is above the third setting value, and the third setting value may be higher than the first setting value.

In the control device, the controller may compare whether or not the amplitude of the detection signal is above a fourth setting value, when the intensity of the detection signal is below the first setting value, and the fourth setting value may be lower than the second setting value.

In the control device, the controller may determine the user's state as a moving state when the amplitude of the detection signal is above the fourth setting value.

In the control device, the controller may determine the user's state as a stationary state when the amplitude of the detection signal is below the fourth setting value.

In the control device, the controller may configure the user's initial input position as one of the following: upward, downward, leftward, or rightward with respect to the center portion, when the touch motion is activated.

According to still another of embodiments, there is provided a method of control, the method including: a step of receiving a detection signal; a step of determining a user's state; a step of determining activation of a gesture motion or a touch motion in a manner that corresponds to the user's determined state; and a step of transmitting a command in a manner that corresponds to the activated motion.

In the method of control, the step of determining a user's state may include a step of comparing whether the amplitude of a detection signal is above a second setting value, when the intensity of the detection signal above a first setting value.

The method of control may include a step of determining the user's state as an exercise when the amplitude of the detection signal is above the second setting value.

The method of control may include a step of comparing whether the intensity of the detection signal is above a third setting value when the amplitude of the detection signal is below the second setting value.

The method of control may include a step of determining the user's state as a riding when the intensity of the detection signal is above the third setting value,
wherein the third setting value may be higher than the first setting value.

The method of control may include a step of comparing whether or not the amplitude of the detection signal is above a fourth setting value when the intensity of the detection signal is below the first setting value, wherein the fourth setting value may be lower than the second setting value.

The method of control may include a step of determining the user's state as a moving state when the amplitude of the detection signal is above the fourth setting value.

The method of control may include a step of determining the user's state as a stationary state when the amplitude of the detection signal is below the fourth setting value.

According to a yet another aspect of the embodiments, there is provided an electronic device including: a frame; an optical device a arranged on the frame and generating an image, a display unit connected to the optical device and outputting an image generated by the optical device; and a heat dissipation unit connected to the optical device and arranged within the frame.

In the electronic device, the optical may include a barrel on which a plurality of lenses are arranged; an opening portion formed in a lateral surface of the barrel, and a light source device coupled to the opening portion.
wherein the light source device may include:
a housing in which an opening is formed;
a light source emitting light to the second light guide; and
a substrate connected to the light source.

In the electronic device, the heat dissipation unit may come into contact with the substrate.

In the electronic device, the heat dissipation unit may extend from the external surface of the housing to the frame.

In the electronic device, the optical device may include an optical signal generation unit generating an optical signal including image information, wherein the heat dissipation unit may extend in a manner that is adjacent to the optical signal generation unit.

The electronic device may include a heat supply unit arranged on the frame.

In the electronic device, the heat supply unit and the heat dissipation unit may be arranged to be spaced apart from each other.

In the electronic device, the frame may include: an upper region; and a lower region arranged underneath the upper region, wherein either the heat supply unit or the heat dissipation unit is arranged in the upper region, and the remaining unit may be arranged in the lower region.

In the electronic device, the heat dissipation unit may be arranged along the external surface of the frame.

### Advantageous Effects

According to the embodiments, an optical device capable of accurately detecting a user's bio-signals using Augmented Reality (AR) or signal technologies, and an electronic device including the optical device can be realized.

In addition, an optical device capable of reducing noise in sensing signals (bio-signals) and an electronic device including the optical device can be realized.

In addition, an optical device capable of accurately whether or not a user is wearing an electronic device and an electronic device including the optical device can be realized.

In addition, an optical device capable of achieving improved electric power efficiency and an electronic device including the optical device can be realized.

In addition, an electronic device capable of generating an image based on a user's eyesight, using Augmented Reality (AR) or signal technologies, and a method of display.

In addition, an electronic device capable of comfortably enabling a user to recognize a virtual image or similar content through an image selected by the user and a method of display can be realized.

In addition, a control device capable of reducing malfunctions by activating an input type in a manner that corresponds to a user's state, using Augmented Reality (AR) or signal technologies, and a method of control can be realized.

In addition, a control device capable of intuitively controlling an electronic device without drawing the attention of others, and a method of control can be realized.

In addition, an optical device capable of easily suppressing a fogging phenomenon, and an electronic device including the optical device can be realized.

In addition, an optical device capable of achieving improved reliability through heat dissipation, and an electronic device including the optical device can be realized.

In addition, an optical device capable of achieving improved energy efficiency, and an electronic device including the optical device can be realized.

Various useful advantages and effects of the present invention are not limited to those mentioned above and can be better understood from detailed descriptions of the embodiments of the present invention.

### DESCRIPTION OF DRAWINGS

FIG. 1 is a conceptual view illustrating an embodiment of an AI apparatus.

FIG. 2 is a block diagram illustrating the configuration of an extended reality electronic device according to an embodiment of the present invention.

FIG. 3 is a perspective view illustrating an augmented reality electronic device according to a first embodiment of the present invention.

FIGS. 4(a)-6(c) are conceptual views that are referenced to describe various display techniques that are applicable to a display unit according to an embodiment of the present invention.

FIG. 7 is a conceptual diagram illustrating an electronic device according to an embodiment and an optical device thereof.

FIG. 8 is a conceptual diagram illustrating an optical device according to an embodiment.

FIG. 9 is a perspective view illustrating the optical device according to the embodiment.

FIG. 10 is an exploded perspective view illustrating the optical device according to the embodiment.

FIG. 11 is a cross-sectional view taken along line A-A′ on FIG. 9.

FIG. 12 is an enlarged view illustrating Portion K1 of FIG. 11.

FIG. 13 is an enlarged view illustrating Portion K2 of FIG. 11.

FIG. 14 is a view illustrating another example of the light source device according to the embodiment.

FIG. 15 is a flowchart illustrating a method of operation of either the electronic device according to the embodiment or the optical device thereof.

FIG. 16 is a timing chart that is referenced to describe respective operations of a light source, an optical signal generation unit, and a light reception unit.

FIG. 17 is a flowchart illustrating a method of display according to an embodiment.

FIG. 18 is an additional flowchart illustrating the method of display according to the embodiment.

FIGS. 19(a)-20 are views that are referenced to describe eyesight determination in the method of display according to the embodiment.

FIG. 21 is a view illustrating the output of an image in the method of display according to the embodiment.

FIG. 22 is a flowchart illustrating a method of display according to another embodiment.

FIG. 23 is a view that is referenced to describe eyesight determination in the method of display to the same embodiment.

FIG. 24 is a flowchart illustrating a method of display according to a still another embodiment.

FIG. 25 is a perspective view illustrating an augmented reality electronic device, as a modification example, according to an embodiment.

FIG. 26 is a block diagram illustrating a control device according to an embodiment of the present invention.

FIG. 27 is a conceptual diagram illustrating the control device according to the embodiment of the present invention.

FIG. 28 is a flowchart illustrating a method of control according to an embodiment of the present invention.

FIG. 29 is a specific flowchart illustrating the method of control according to the embodiment of the present invention.

FIG. 30 is a view that is referenced to describe operation of the control device according to the embodiment of the present invention and the method of control.

FIG. 31 is a view that is referenced to describe operation and control between the control device according to the embodiment of the present invention and an electronic device.

FIG. 32 is a view illustrating an interface of an electronic device according to an embodiment of the present invention.

FIG. 33 is a view that is referenced to describe operation of the electronic device that uses the control device according to the embodiment of the present invention.

FIG. 34 is a view that is referenced to describe the control device according to the embodiment of the present invention.

FIG. 35 is a side view illustrating an electronic device according to an embodiment.

FIG. 36 is a plan view illustrating the electronic device according to the embodiment.

FIG. 37 is a conceptual diagram illustrating an optical device according to an embodiment.

FIG. 38 is a perspective view illustrating the optical device according to the embodiment.

FIG. 39 is an exploded perspective view illustrating the optical device according to the embodiment.

FIG. 40 is a view taken along line AA′ on FIG. 38.

FIG. 41 is an enlarged view illustrating Portion K1 of FIG. 40.

FIG. 42 is an enlarged view illustrating Portion K2 of FIG. 40.

FIG. 43 is a side view illustrating an electronic device according to another embodiment.

FIG. 44 is a plan view illustrating the electronic device according to the same embodiment.

FIG. 45 is a side view illustrating an electronic device according to still another embodiment.

FIG. 46 is a plan view illustrating the electronic device according to the same embodiment.

### MODE FOR INVENTION

Preferred embodiments of the present invention will be described in detail below with reference to the accompanying drawings.

However, the technical idea of the present invention is not limited to one or several described embodiments and may be implemented in various different forms. One or more constituent elements of these embodiments may be used through selective coupling and substitution within the scope of the technical idea of the present invention.

In addition, unless otherwise definitely defined and used, terms (including technical and scientific terms) used in the embodiment of the present invention may be construed as having the meaning normally understandable to a person of ordinary skill in the art to which the present invention pertains. Terms used normally like those defined in dictionaries may be construed to have the meanings defined considering contextual meaning in the pertinent technology.

In addition, the terms used in the embodiments of the present invention are used to describe them and are not intended to impose any limitation on the present invention.

Throughout the present specification, singular nouns are intended to include their plural forms, unless the context explicitly dictates otherwise. In a case where the expression “at least one (or one or more) of the following: A, B, or C” is used, the expression may be construed to include one or more of combinations made up of A, B, and C, whether individually or collectively.

In addition, the terms first, second, and so on, A, B, and so on, and (a), (b), and so on may be used in describing constituent elements according to the embodiments of the present invention.

These terms are used only to distinguish one constituent element from another and do not impose limitations on the nature, order, or sequence of these constituent elements.

In a case where one constituent element is described as being “connected to,” “coupled to,” or “having access to” another constituent element, it may be directly connected to, directly coupled to, or have direct access to the other constituent element. Furthermore, it may be connected to, coupled to, or have direct access to the other constituent element with an intervening constituent element in between.

In addition, in a case where one constituent element is described as being formed or arranged “on top of” or “underneath” another constituent, it may be in direct contact with the other element. Furthermore, in a case where one constituent element is described as being formed or arranged “over” or “under” another constituent, it may be formed or arranged with one or more intervening constituent elements in between. In addition, in a case where one constituent element is described as being on top of (over) or underneath (below) another element, the upward and downward directions may be defined relative to the position of one of these elements.

FIG. 1 is a conceptual view illustrating an embodiment of an AI apparatus.

With reference to FIG. 1, in an AI system, at least one of the following—an AI server 16, a robot 11, a self-driving vehicle 12, an XR device 13, a smartphone 14, or a home appliance 15—is connected to a cloud network 10. At this point, the robot 11, the self-driving vehicle 12, the XR device 13, the smartphone 14, the home appliance 15, and similar apparatuses, to all of which AI technology applies, are referred to as AI apparatuses 11 to 15.

The cloud network 10 may constitute one portion of a cloud computing infrastructure or refer to a network that is present within the cloud computing infrastructure. At this point, the cloud network 10 may be configured using a 3G network, a 4G or Long Term Evolution (LTE) network, a 5G network, or a similar network.

That is, the apparatuses 11 to 16 that constitute the AI system may be connected to one another through the cloud network 10. Particularly, the apparatuses 11 to 16 may communicate with one another through a base station and also directly communicate with one another without the base station in between.

The AI server 16 may include a server that performs AI processing and a server that performs computation on big data.

The AI server 16 may be connected through the cloud network 10 to at least one of the AI apparatuses, including the robot 11, the self-driving vehicle 12, the XR device 13, the smartphone 14, and the home appliance 15, that constitute the AI system. The AI server 16 may assist the AI apparatuses 11 to 15, to which the AI server 16 is connected, in performing at least one portion of AI processing.

At this point, on behalf of the AI apparatuses (11 to 15), the AI server 16 may train an artificial intelligence network according to machine learning algorithms and directly store a learning model or transmit the learning model to the AI apparatuses 11 to 15.

The AI server 16 may receive input data from the AI apparatuses 11 to 15, deduce a resultant value for the received input data using the learning model, generate a response or control command that is based on the deduced resultant value, and transmit the generated response or control command to the AI apparatuses 11 to 15.

Alternatively, the AI apparatuses 11 to 15 may deduce a resultant value for input data using the learning model directly and also generate a response or control command that is based on the deduced resultant value.

### <AI+Robot>

The robot 11 may be implemented as a guide robot, a carrying robot, a cleaning robot, a wearable robot, an entertainment robot, a pet robot, an unmanned flying robot, or the like, to each of which AI technology applies.

The robot 11 may include a robot control module for controlling the operation thereof, and the robot control module may refer to a software module or a chip that results from implementing the software module in hardware.

Using sensor information acquired from various types of sensors, the robot 11 may acquire its status information, detect (recognize) its surrounding environment and object, generate map data, determine its movement path and driving plan, determine a response to an interaction with a user, or determine its operation.

At this point, in order to determine its movement path and driving plan, the robot 11 may use sensor information acquired from at least one sensor of the following: a LiDAR, a radar, or a camera.

The robot 11 may perform the above-described operations using a learning model configured with at least one artificial intelligence network. For example, the robot 11 may recognize its surrounding environment and object using the learning model and determine its operation using either information about its recognized surrounding environment or object information. At this point, the learning model may result either from direct learning in the robot 11 or from learning in an external apparatus, such as the AI server 16.

At this point, the robot 11 may generate a result directly using the learning model and perform its operation. However, the robot 11 may also transmit the sensor information to an external apparatus, such as the AI server 16, receive a result generated according to the sensor information, and perform its operation.

The robot 11 may determine its movement path and driving plan and control a drive unit using at least one of the following: map data, object information detected from the sensor information or object information acquired from an external apparatus. Thus, the robot 11 may drive according to its determined movement path and driving plan.

The map data may include object identification information about various objects arranged within the space into which the robot 11 moves. For example, the map data may include object identification information about fixed objects, such as a wall and a door, and about movable objects, such as a flowerpot and a desk. Then, the object identification information may include an object's name, type, distance, location, and the like.

In addition, the robot 11 may control the drive unit either under the control of the user or based on the interaction with the user, and thus may perform its operation or driving. At this point, the robot 11 may acquire intent information of the interaction that interprets from the user's movement and voice utterance, determine a response based on the acquired intention information, and perform its operation.

### <AI+Self-Driving>

The self-driving vehicle 12 may be implemented as a mobile robot, a vehicle, an unmanned flying object, or the like to each of which AI technology applies.

The self-driving vehicle 12 may include a self-driving control module for controlling its self-driving function, and the self-driving control module may refer to a software module or a chip that results from implementing the software module in hardware. The self-driving control module may be included, as a component, within the self-driving vehicle 12. However, the self-driving control module may also be configured as a separate hardware component and connected externally to the self-driving vehicle 12.

Using sensor information acquired from various types of sensors, the self-driving vehicle 12 may acquire its status information, detect (recognize) its surrounding environment and object, generate map data, determine its movement path and driving plan, or determine its operation.

At this point, in order to determine its movement path and driving plan, the self-driving vehicle 12, like the robot 11, may use sensor information acquired from at least one of the following: a LiDAR, a radar, or a camera.

Particularly, the self-driving vehicle 12 may recognize a region hidden from sight, or an environment of, or object in, a region located a predetermined distance away using sensor information from external apparatuses. Alternatively, the self-driving vehicle 12 may receive information recognized directly from external apparatuses.

The self-driving vehicle 12 may perform the above-described operations using a learning model configured with at least one artificial intelligence network. For example, the self-driving vehicle 12 may recognize its surrounding environment and object using the learning model and determine its driving route using information about its recognized environment or object. At this point, the learning model may result either from direct learning in the self-driving vehicle 12 or from learning in an external apparatus, such as the AI server 16.

At this point, the self-driving vehicle 12 may generate a result directly using the learning model and perform its operation. However, the self-driving vehicle 12 may also transmit the sensor information to an external apparatus, such as the AI server 16, receive a result generated according to the sensor information, and perform its operation.

The self-driving vehicle 12 may determine its movement path and driving plan and control a drive unit using at least one of the following: map data, object information detected from the sensor information or object information acquired from an external apparatus. Thus, the self-driving vehicle 12 may drive according to its determined movement path and driving plan.

The map data may include object identification information about various objects arranged within the space (for example, a road) into which the self-driving vehicle 12 moves. For example, the map data may include object identification information about fixed objects, such as a streetlight, a rock, and a building, and about movable objects, such as a vehicle and a pedestrian. Then, the object identification information may include an object's name, type, distance, location, and the like.

In addition, the autonomous travel vehicle 12 may control the drive unit either under the control of the user or based on the interaction with the user, and thus may perform its operations or travel. At this point, the self-driving vehicle 12 may acquire intent information of the interaction that interprets from the user's movement and voice utterance, determine a response based on the acquired intention information, and perform its operation.

$$< AI + XR >$$

The XR device 13 may be implemented as a head-mount display (HMD), a head-up display (HUD) provided in a vehicle, a television, a mobile phone, a smartphone, a computer, a wearable device, a home appliance, digital signage, a vehicle, a stationary robot, a mobile robot, or the like, to each of which AI technology applies.

The XR device 13 may generate location data and attribute data on three-dimensional points by analyzing three-dimensional point cloud data or image data, which are acquired either through various sensors or from an external apparatus. Thus, the XR device 13 may acquire information about a surrounding space or a real object, render an XR object to be output, and output the XR object. For example, the XR device 13 may output an XR object, including additional information about the recognized object, in a manner that corresponds to the recognized object.

The XR device 13 may perform the above-described operations using a learning model configured with at least one artificial intelligence network. For example, the XR device 13 may recognize a real object from the three-dimensional point cloud data or the image data using the learning model and provide information corresponding to the recognized real object. At this point, the learning model may result either from direct learning in the XR device 13 or from learning in an external apparatus, such as the AI server 16.

At this point, the XR device 13 may generate a result directly using the learning model and perform its operation. However, the XR device 13 may also transmit the sensor information to an external apparatus, such as the AI server 16, receive a result generated according to the sensor information, and perform its operation.

$$< AI + Robot + Self - Driving >$$

The robot 11 may be implemented as a guide robot, a carrying robot, a cleaning robot, a wearable robot, an entertainment robot, a pet robot, an unmanned flying object, or the like, to each of which AI technology and self-driving technology apply.

The robot 11, to which AI technology and self-driving technology apply, may refer to a robot itself equipped with a self-driving function, the robot 11 that interacts with the self-driving vehicle 12, or a similar type of robot.

The robots 11, each equipped with a self-driving function, may collectively refer to apparatuses that either move by themselves along given routes without the control of the user or independently determine their routes and move along their determined routes.

The robot 11 and the self-driving vehicle 12, both equipped with a self-driving function, may use a common sensing method in order to determine one or more of the following: the movement path or the driving plan. For example, the robot 11 and the self-driving vehicle 12, both equipped with a self-driving function, may determine at least one of the following—the movement path or the driving plan—using information sensed through a LiDAR, a radar, and a camera.

The robot 11, which interacts with the self-driving vehicle 12, may be present separately from the self-driving vehicle 12 and either operate in conjunction with the self-driving function inside or outside the self-driving vehicle 12 or perform an operation in conjunction with the user riding in the self-driving vehicle 12.

At this point, the robot 11, which interacts with the self-driving vehicle 12, may acquire the sensor information on behalf of the self-driving vehicle 12 and provide the acquired sensor information to the self-driving vehicle 12. Alternatively, the robot 11 may acquire the sensor information, generate either information on the surrounding environment or object information, and provide the generated information to the self-driving vehicle 12. Thus, the robot 11 may control or assist the self-driving vehicle 12 in performing its self-driving function.

Alternatively, the robot 11, which interacts with the self-driving vehicle 12, may either monitor the user riding in the self-driving vehicle 12 or control functions of the self-driving vehicle 12 through the interaction with the user. For example, in a case where it is determined that the driver is drowsy, the robot 11 may either activate the self-driving function of the self-driving vehicle 12 or assist the self-driving vehicle 12 in controlling the drive unit. At this point, the functions of the self-driving vehicle 12, which are controlled by the robot 11, may include not only a self-driving function, but also a function provided in either a navigation system or an audio system provided within the self-driving vehicle 12.

Alternatively, the robot 11, which interacts with the self-driving vehicle 12, may either provide information to the self-driving vehicle 12 from outside the self-driving vehicle 12, or assist the self-driving vehicle 12 in performing its functions. For example, the robot 11, like smart traffic signals, may also provide traffic information, including signal information or similar information, to the self-driving vehicle 12. Furthermore, the robot 11, like an automatic electric charging station for electric vehicles, may also automatically connect an electric charger to a charging inlet by interacting with the self-driving vehicle 12.

$$< AI + Robot + XR >$$

The robot 11 may be implemented as a guide robot, a carrying robot, a cleaning robot, a wearable robot, an entertainment robot, a pet robot, an unmanned flying robot, a drone, or the like, to each of which AI technology and XR technology apply.

The robot 11, to which XR technology applies, may refer to a robot that is subject to control or interaction within an XR image. In this case, the robot 11 is distinguished from the XR device 13 and may operate in conjunction with the XR device 13.

When the robot 11, which is subject to control or interaction within an XR image, obtains sensor information from sensors including a camera, the robot 11 or the XR device 13 may generate an XR image based on the sensor information, and the XR device 13 may output the generated XR image. Then, the robot 11 may operate based on either a control signal input through the XR device 13 or interaction with the user.

For example, the user can remotely check an XR image corresponding to a point in time for the robot 11, which operates in conjunction with an external device, through the external device, such as the XR device 13. Furthermore, through the interaction, the user can adjust a self-driving path for the robot 11, control the operation or driving of the robot 11, or check information about a nearby object.

$$< AI + Self - Driving + XR >$$

The self-driving vehicle 12 may be implemented as a mobile robot, a vehicle, an unmanned flying object, or the like, to each of which AI technology and XR technology apply.

The self-driving vehicle 12, to which XR technology applies, may refer to a self-driving vehicle equipped with a means of providing an XR image, a self-driving vehicle that is subject to control or interaction within an XR image, or a similar type of vehicle. Particularly, the self-driving vehicle 12, which is subject to control or interaction within an XR image, is distinguished from the XR device 13 and may operate in conjunction with the XR device 13.

The self-driving vehicle 12 equipped with a means of providing an XR image may acquire sensor information from sensors including a camera and output an XR image generated based on the acquired sensor information. For example, the self-driving vehicle 12 may include a HUD and output an XR image. Thus, the self-driving vehicle 12 may provide an XR object, corresponding to either a real object or an object within a screen, to an occupant.

At this point, in a case where an XR object is output on the HUD, at least one portion of the XR object may be output in such a manner as to overlap with a real object on which the occupant keeps his/her gaze. In contrast, in a case where an XR object is output on a display provided within the self-driving vehicle 12, at least one portion of the XR object may be output in such a manner as to overlap with an object within a screen. For example, the self-driving vehicle 12 may output XR objects that correspond to objects, respectively, such as a vehicle road, another vehicle, traffic signals, traffic signs, a two-wheel vehicle, a pedestrian, and a building.

When the self-driving vehicle 12, which is subject to control or interaction within an XR image, obtains sensor information from sensors including a camera, the self-driving vehicle 12 or the XR device 13 may generate an XR image based on the sensor information, and the XR device 13 may output the generated XR image. Then, the self-driving vehicle 12 may operate based on either a control signal input through an external device, such as the XR device 13, or interaction with the user.

### [Extended Reality Technology]

Extended reality (XR) collectively refers to virtual reality (VR), augmented reality (AR), and mixed reality (MR). Virtual technology provides objects or backgrounds in the real world as CG images only. AR technology additionally provides a CG image virtually generated onto an actual object image. MR technology is a computer graphic technology that presents virtual objects in a manner that is seamlessly integrated into the real world.

MR technology presents a real object and a virtual object together. In this respect, MR technology is similar to AR technology. However, AR technology is used in the form of supplementing a real object with a virtual object. In contrast, MR technology is used with the concept that a virtual object and a real object coexist and interact as equals. In this respect, AR technology differs from MR technology.

XR technology may apply to a head-mount display (HMD), a head-up display (HUD), a mobile phone, a tablet PC, a laptop computer, a desktop computer, a TV, digital signage, and the like. A device to which XR technology applies may be referred to as an XR device.

An electronic device according to an embodiment of the present invention, which provides Extended Reality, is described below. Particularly, an optical device that finds application in Augmented Reality and an electronic device including the optical device are described in detail.

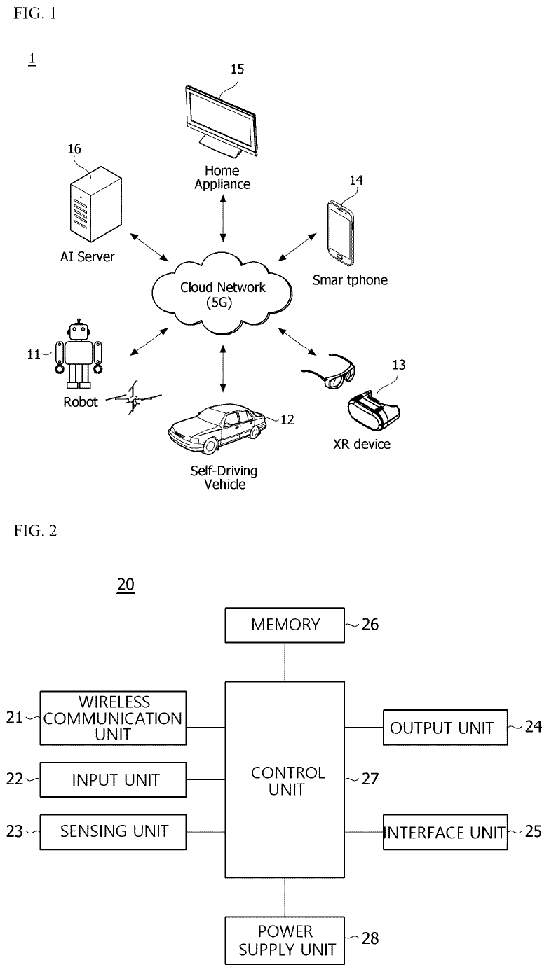

FIG. 2 is a block diagram illustrating the configuration of an extended reality electronic device 20 according to an embodiment of the present invention.

With reference to FIG. 2, the extended reality electronic device 20 may include a wireless communication unit 21, an input unit 22, a sensing unit 23, an output unit 24, an interface unit 25, a memory 26, a control unit 27, a power supply unit 28, and other similar units. Constituent elements illustrated in FIG. 2 are not essential for implementing the electronic device 20. The electronic device 20 described in the present specification may have more or fewer constituent elements than those enumerated above.

More specifically, among the constituent elements enumerated above, the wireless communication unit 21 may include one or more modules that enable wireless communication between the electronic device 20 and a wireless communication system, between the electronic device 20 and another electronic device, or between the electronic device 20 and an external server. In addition, the wireless communication unit 21 may include one or more modules that connect the electronic device 20 to one or more networks.

The wireless communication unit 21 may include at least one of the following: a broadcast reception module, a mobile communication module, a wireless Internet module, a short-range communication module, or a location information module.

The input unit 22 may include a camera or image input unit for inputting an image signal, a microphone or audio input unit for inputting an audio signal, and a user input unit (for example, a touch key, a push key (mechanical key), and the like) for receiving information, as input, from a user. Voice data or image data that are collected through the input unit 22 may be analyzed and be processed as the user's control command.

The sensing unit 23 may include at least one sensor in order to sense at least one of the following: information within the electronic device 20, information about the surrounding environment of the electronic device 20, or user information.

For example, the sensing unit 23 may include at least one of the following: a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (for example, an image capture means), a microphone, a battery gauge, an environment sensor (for example, a barometer, a hygrometer, a thermometer, a radiation detection sensor, a thermal sensor, a gas sensor, or the like), or a chemical sensor (for example, an electronic nose, a health care sensor, a biometric sensor, or the like). The electronic device 20 disclosed in the present specification may utilize, in combination, information pieces sensed in at least two of these sensors.

The output unit 24 serves to generate an output associated with a sense of sight, a sense of hearing, or a sense of touch, and may include at least one of the following: a display unit, a sound output unit, a haptic module, or a light output unit. The display unit is configured to be structurally layered with a touch sensor or is integrally formed with the touch sensor, thereby being implemented as a touch screen. This touch screen may function as a user input means that provides an input interface between the extended reality electronic device 20 and the user and, at the same time, may provide an output interface between the extended reality electronic device 20 and the user.

The interface unit 25 serves as a path to various external apparatuses that are connected to the electronic device 20. The electronic device 20 may be provided with virtual reality or augmented reality content from an external apparatus through the interface unit 25 and perform mutual interaction by exchanging various input signals, sensing signals, and data with the external apparatus.

For example, the interface unit 25 may include at least one of the following: a wired/wireless headset port, an external charger port, a wired or wireless data port, a memory card port, a port for connecting to an apparatus including an identification module, an audio input/output (I/O) port, a video input/output (I/O) port, or an earphone port.

In addition, data for supporting various functions of the electronic device 20 are stored in the memory 26. Examples of the memory 26 may include a read-only memory (ROM), a random access memory (RAM), a flash memory, a memory card, a storage medium, and other storage devices. A multiplicity of application programs (or programs) that are executed on the electronic device 20, data for operating the electronic device 20, and commands may be stored in the memory 26. At least one or several of these application programs may be downloaded from an external server through wireless communication. At least one or several of these application programs may be pre-installed on the electronic device 20 before shipping from the factory to perform basic functions (for example, receiving a call, placing a call, receiving a message, and sending a message) of the electronic device 20.

The control unit 27 normally controls the overall operation of the electronic device 20 in addition to operations associated with the application programs. The control unit 27 may process signals, data, information, and the like that are input or output through the constituent elements described above.

In addition, the control unit 27 may control at least one or several of the constituent elements by executing the applications programs stored in the memory 26, thereby providing or perform information or functions, respectively, which are appropriate to the user. Moreover, the control unit 27 may operate, in combination, at least two of the constituent elements included in the electronic device 20 in order to execute the application program. Moreover, the control unit 27 may perform processing for a driving method described below. The control unit 27 may be expressed as a processor, a control part, or the like. In addition, the control unit 27 may include an application-specific integrated circuit (ASIC), a different chipset, a logic circuit, and/or a data processing device.

In addition, the control unit 27 may detect the movement of the electronic device 20 or the user's movement using a gyroscope sensor, a gravity sensor, a motion sensor, and other sensors, which are included in the sensing unit 23. Alternatively, the control unit 27 may also detect an object approaching the vicinity of either the electronic device 20 or the user using a proximity sensor, an illumination sensor, a magnetic sensor, an infrared (IR) sensor, an ultrasonic sensor, an optical sensor, and other sensors, which are included in the sensing unit 23. Additionally, the control unit 27 may also detect the user's movement through sensors provided in a controller that operates in conjunction with the electronic device 20.

In addition, the control unit 27 may perform the operation (or function) of the electronic device 20 using the application program stored in the memory 26.

Under the control of the control unit 27, the power supply unit 28 is supplied with electric power from an external or internal power source and supplies the electric power to the constituent elements included in the electronic device 20. The power supply unit 28 may include a battery, and the battery may be provided in a built-in or replaceable form.

At least one or several of the constituent elements may cooperatively operate to perform the operation or control of an electronic device according to various embodiments or to execute the method of controlling the electronic device. In addition, the operation or control of the electronic device or a method of controlling an electronic device may be implemented on the electronic device by executing at least one application program stored in the memory 26.

An electronic device is described below, taking as an example an embodiment of the present invention that finds application in a head-mounted display (HMD). However, embodiments of the electronic device 20 according to the present invention may include a mobile phone, a smartphone, a laptop computer, a digital broadcast-dedicated terminal, a personal digital assistant (PDA), a portable multimedia player (PMP), a navigation device, a slate PC, a tablet PC, an ultrabook computer, a wearable device, and the like. In addition to an HMD, wearable devices may include a watch-type terminal (smartwatch), contact lens, VR/AR/MR glasses, and the like.

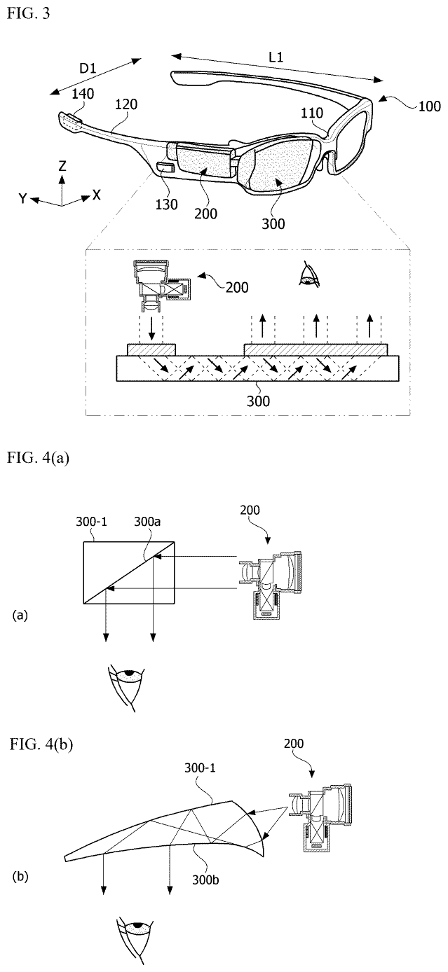

FIG. 3 is a perspective view illustrating an augmented reality electronic device according to an embodiment of the present invention.

As illustrated in FIG. 3, an electronic device according to the embodiment of the present invention may include a frame 100, an optical device 200, and a display unit 300.

The electronic device may be provided in the form of smart glasses. The electronic device 20 in the form of smart glasses may be configured to be wearable on the human head and may include a frame (casing, housing, or the like) 100 for this purpose. The frame 100 may be formed of flexible material in such a manner as to be easy to wear.

The frame 100 is supported on the human head and provides a space for mounting various types of components. As illustrated, electronic components, such as the optical device 200, a user input unit 130 or a sound output unit 140, may be mounted on the frame 100. In addition, a lens that is positioned in front of at least one of the user's left and right eyes may be removably attached to the frame 100.

The frame 100, as illustrated in the drawing, may have the form of glasses worn on the user's face, but is not necessarily limited thereto. The frame 100 may also have the form of a goggle or a similar configuration tightly worn on the user's face.

The frame 100 may include a front frame 110 including at least one opening portion and a pair of lateral frames 120 that extend in parallel with each other in the y direction (in FIG. 3), intersecting the front frame 110.

The frame 100 may have a length DI in the x direction and a length LI in the y direction that are the same or different from each other.

The optical device 200 is configured to control various types of electronic components provided in the electronic device.

The optical device 200 may generate an image or a sequence of images that are visible to the user. The optical device 200 may include an image source panel, a plurality of lenses, and the like. The image source panel generates an image. The plurality of lenses diffuses or converges light generated from the image source panel.

The optical device 200 may be fixed to any one lateral frame 120 of the pair of lateral frames 120. For example, the optical device 200 is fixed on the inside or outside of any lateral frame 120 or may be integrally formed in a manner that is built into the lateral frame 120. Alternatively, the optical device 200 may be fixed to the front frame 110 or may also be provided separately from the electronic device.

The display unit 300 may be implemented in the form of a head-mounted display (HMD). The form of an HMD refers to a display technique that makes an image visible directly in front of the user's eyes. The display unit 300 may be arranged in a manner that corresponds to at least one of the user's left and right eyes, so that, when the user wears the electronic device 20, an image is provided directly in front of the user's eyes. The present drawings illustrate that the display unit 300 is positioned in a portion that corresponds to the user's right eye, so that an image is output toward the user's right eye. However, the display unit 300 is not limited to the portion as described above. The display units 300 may also be arranged in portions that correspond to the user's right and left eyes, respectively.

The display unit 300 may be configured in such a manner that the user visually recognizes the surrounding environment and that, at the same time, an image generated by the optical device 200 is visible to the user. For example, the display unit 300 may project an image onto a display region using a prism.

Moreover, the display unit 300 may be formed of transparent material so that the projected image and the natural field of vision in the forward direction (a range of the user's visual perception) are visible at the same time. For example, the display unit 300 may be semitransparent and formed of optical members, including glass.

Then, the display unit 300 may be fixed to the front frame 110 by being inserted into the opening portion included therein. Alternatively, the display unit 300 may be fixed to the front frame 110 by being positioned on the rear surface (that is, between the opening portion and the user) of the opening portion. The drawings illustrate, as an example, the case where the display unit 300 is positioned on the rear surface of the opening portion, thereby being fixed to the front frame 110. Otherwise, the display unit 300 may be arranged and fixed at various positions on the frame 100.

As illustrated in FIG. 3, in the electronic device, when the optical device 200 directs image light for an image toward one side of the display unit 300, the image light is emitted from the other side of the display unit 300. Thus, the image generated by the optical device 200 may be visible to the user.

Accordingly, the user can view the external environment through the opening portion in the frame 100 and, at the same time, view the image generated by the optical device 200 together. That is, the image output through the display unit 300 can be viewed in a manner that overlaps with the natural field of vision. The electronic device may provide Augmented Reality (AR) that superimposes a virtual image onto a real image or background using these display characteristics and displays the result of the superimposition as one image.

Moreover, in addition to performing this driving operation, the electronic device may provide the external environment and the image generated by the optical device 200 to the user with a time lag for a brief period that is imperceptible to the human. For example, in one section of one frame, the external environment is provided to the user, and in the other section, an image from the optical device 200 may be provided to the user.

Alternatively, both overlapping and time lag may also be provided.

FIGS. 4(a)-6(c) are conceptual views that are referenced to describe various display techniques that are applicable to a display unit according to an embodiment of the present invention.

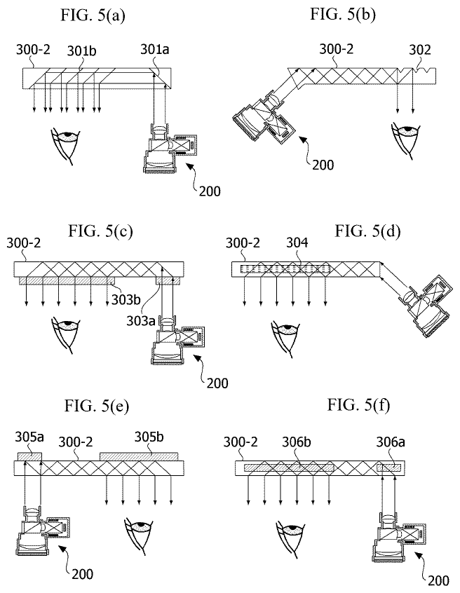

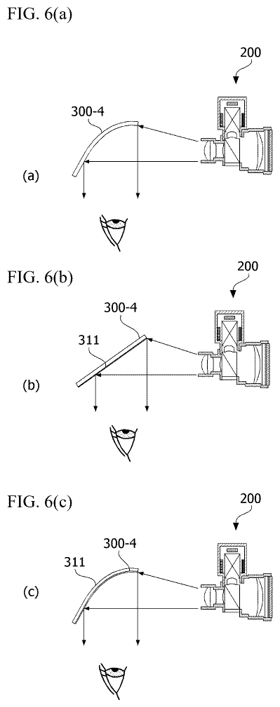

Specifically, FIGS. 4(a) and 4(b) are views that is referenced to describe an embodiment of an optical member that employs a prism technique. FIGS. 5(a)-5(f) are views that is referenced to describe an embodiment of an optical member that employs waveguide technique. FIGS. 6(a)-6(c) are views that is referenced to an embodiment of an optical member that employs a surface reflection technique.

As illustrated in FIGS. 4(a) and 4(b), the optical member that employs the prism technique may be used in a display unit 300-1 according to an embodiment of the present invention.

As an embodiment of the optical member that employs the prism technique, as illustrated in FIG. 4(a), a flat-type glass optical member, which has a flat surface on which image light is incident and a flat surface 300a from which the image light is emitted, may be used. Alternatively, as illustrated in FIG. 4(b), a free-form glass optical member, which has a surface 300b from which image light is emitted, may be used, with the surface 300b being formed as a curved surface that does not have a constant curvature radius.

Image light generated by the optical device 200 may be incident on the flat lateral surface of the flat-type glass optical member, be reflected from a total-reflection mirror 300a provided within the flat-type glass optical member, and be emitted toward the user. At this point, the total-reflection mirror 300a to be provided within the flat-type glass optical member may be formed within the flat-type glass optical member using a laser.

The free-form glass optical member is configured in such a manner that the farther the distance from the surface on which light is incident, the smaller the thickness thereof. Thus, the image light generated by the optical device 200 may be incident on the curved-lateral surface of the free-form glass optical member, be totally reflected inside, and be emitted to the user.

As illustrated in FIGS. 5(a)-5(f), the optical member that employs the waveguide technique or a light guide optical element (LOE) may be used in a display unit 300-2 according to another embodiment of the present invention.

As embodiments of the optical member that employs the waveguide or light guide technique, there may be provided a glass optical member that employs a segmented beam splitter technique as illustrated in FIG. 5(a), a glass optical member that employs a sawtooth prism technique as illustrated in FIG. 5(b), a glass optical member that employs a diffractive optical element (DOE) as illustrated in FIG. 5(c), a glass optical member that has a hologram optical element (HOE) as illustrated in FIG. 5(d), a glass optical member that has a passive grating as illustrated in FIG. 5(e), and a glass optical member that has an active grating as illustrated in FIG. 5(f).

As illustrated, the glass optical member that employs the segmented beam splitter technique as illustrated in FIG. 5(a) may include a total-reflection mirror 301a on the side where an optical image is incident and a segmented beam splitter 301b on the side where the optical image is emitted, within the glass optical member.

Accordingly, an optical image generated by the optical device 200 may be totally reflected from the total-reflection mirror 301a within the glass optical member. The totally reflected optical image may be then partially separated and emitted by the segmented beam splitter 301b while being light-guided along the lengthwise direction of the glass, thereby being visually recognized by the user.

In the glass optical member that employs the sawtooth prism technique as illustrated in FIG. 5(b), the image light from the optical device 200 may be incident in an inclined direction on a lateral surface of the glass, be totally reflected inside the glass, and be emitted out of the glass by a sawtooth-shaped raised or grooved section 302 provided on the side where the optical image is emitted, thereby being visually recognized by the user.

The glass optical member that has the diffractive optical element (DOE) as illustrated in FIG. 5(c) may include a first diffractive portion 303a on the surface on the side where an optical image is incident, and a second diffractive portion 303b on the surface on the side where the optical image is emitted. The first and second refraction portions 303a and 303b may be provided in a form that allows a specific pattern to be formed on the surface of the glass or that allows a separate diffractive film to be attached to the surface of the glass.

Accordingly, the optical image generated by the optical device 200 may be diffracted while being incident through the first diffraction portion 303a and be light-guided along the lengthwise direction of the glass while being totally reflected. Then, the optical image is emitted through the second diffraction portion 303b, thereby being visually recognized by the user.

The glass optical member that has the hologram optical element (HOE) as illustrated in FIG. 5(d) may include an out-coupler 304. The out-coupler 304 is positioned within the glass on the side where the optical image is emitted. Accordingly, the optical image may enter in an inclined direction from the optical device 200 through the lateral surface of the glass, be totally reflected, be light-guided along the lengthwise direction of the glass, and be output by the out-coupler 304, thereby being visually recognized by the user. The structure of the hologram optical element may gradually change and thus may be subdivided into a structure with a passive grating and a structure with an active grating.

The glass optical member that has the passive grating as illustrated in FIG. 5(e) may include an in-coupler 305a on the surface opposite the glass surface on the side where the optical image is incident, and an out-coupler 305b on the surface opposite the glass surface on the side where the optical image is emitted. At this point, the in-coupler 305a and the out-coupler 305b may be provided in the form of a film having a passive grating.

Accordingly, the optical image incident on the glass surface, on the side where the optical image is incident, of the glass may be totally reflected by the in-couple 305a positioned on the opposite surface, be light-guided along the lengthwise direction of the glass, and be emitted by the out-coupler 305b through the opposite surface of the glass, thereby being visually recognized by the user.

The glass optical member that has the active grating as illustrated in FIG. 5(f) may include an in-coupler 306a and an out-coupler 306b. The in-coupler 306a is formed, in the form of an active grating, within the glass on the side where the optical image is incident. The out-coupler 306b is formed in the form of an active grating within the glass on the side where the optical image is emitted.

Accordingly, the optical image incident on the glass may be totally reflected by the in-coupler 306a, be light-guided along the lengthwise direction of the glass, and be emitted out of the glass by the out-coupler 306b, thereby being visually recognized by the user.

As a display unit according to a modification example, an optical member that employs a pin mirror technique may be used.

In addition, in order to serve as a coupler, a free-form combiner glass having a plurality of flat surfaces with different incident angles, respectively, for an optical image, which are formed as one glass, may be used as the optical member that employs the surface reflection technique belonging to a free-form combiner technique, as illustrated in FIG. 6(a). An optical image may be incident on a free-form combiner glass 300 in such a manner that the incident angle varies on a per-region basis, thereby being emitted to the user.

The optical member that employs the surface reflection technique employing a flat HOE technique, as illustrated in FIG. 6(b), may include a hologram optical element (HOE) 311, which is coated or patterned on the flat surface of the glass. The optical image incident on the optical device 200 may pass through the hologram optical element 311, be reflected from the surface of the glass, and pass back through the hologram optical element 311, thereby being output toward the user.

The optical member that employs the surface reflection technique belonging to a free-form HOE technique, as illustrated in FIG. 6(c), may include a hologram optical element (HOE) 313, which is coated or patterned on the surface of the glass in a free form. The operation principle behind the optical member is the same as described with reference to FIG. 6(b).

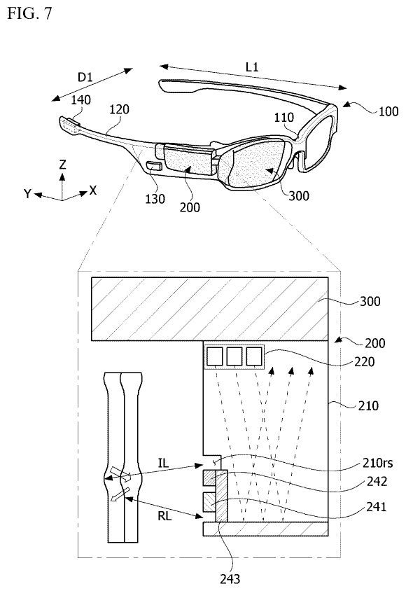

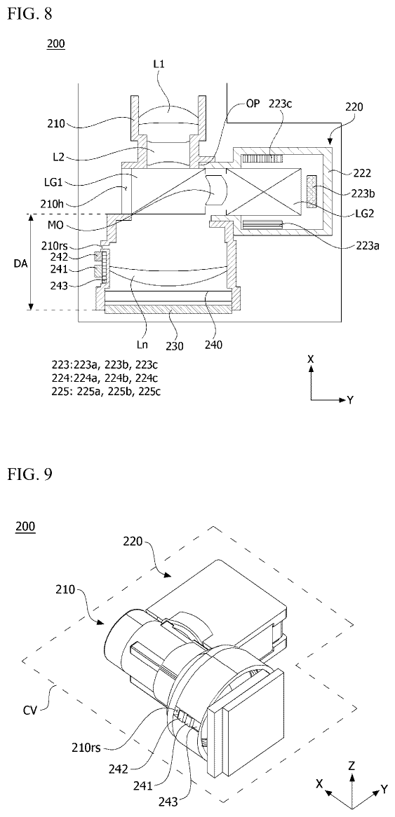

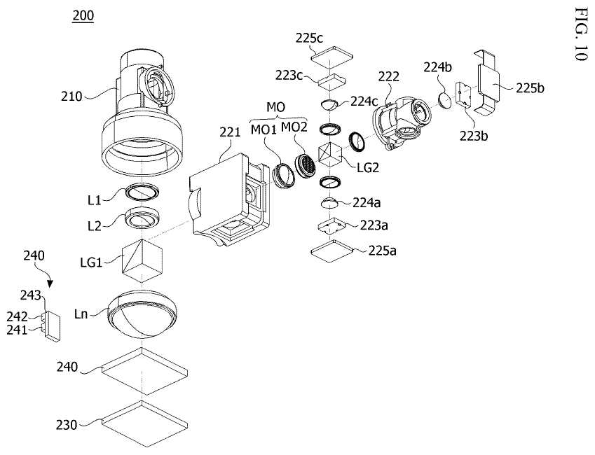

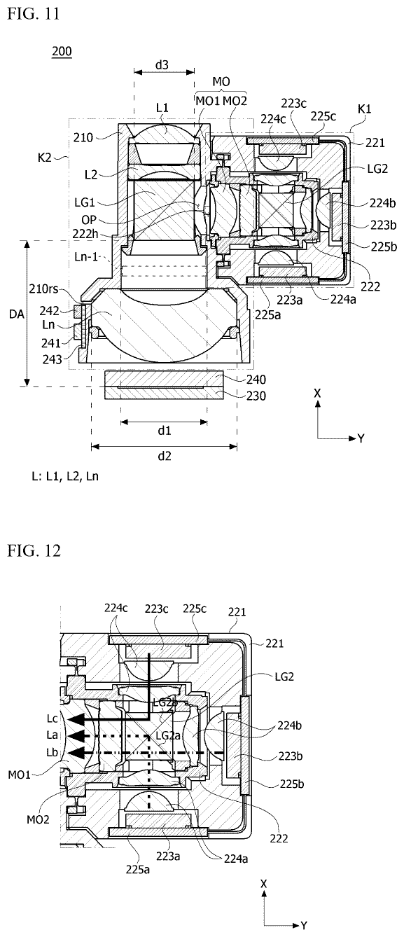

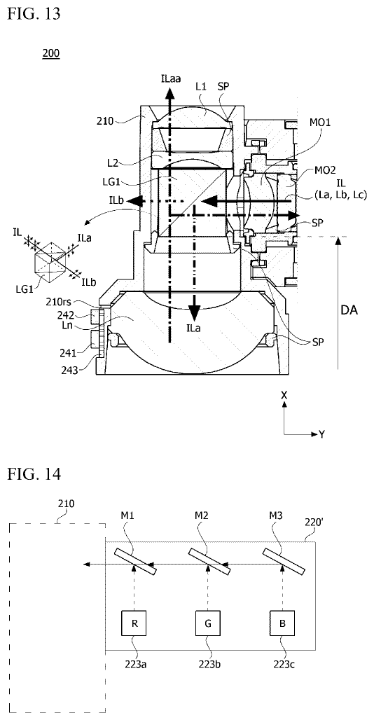

FIG. 7 is a conceptual diagram illustrating an electronic device according to an embodiment and an optical device thereof. FIG. 8 is a conceptual diagram illustrating an optical device according to an embodiment. FIG. 9 is a perspective view illustrating the optical device according to the embodiment. FIG. 10 is an exploded perspective view illustrating the optical device according to the embodiment. FIG. 11 is a cross-sectional view taken along line A-A′ on FIG. 9. FIG. 12 is an enlarged view illustrating Portion K1 of FIG. 11. FIG. 13 is an enlarged view illustrating Portion K2 of FIG. 11.

First, with reference to FIG. 7, an electronic device according to an embodiment, as described above, may include the frame 100, the optical device 200, and the display unit 300.

The optical device 200 may be arranged on the frame 100. The optical device 200 may be connected to the display unit 300 and thus may provide a video or image to the display unit 300. The display unit 300 may be positioned on a transparent lens (for example, a glass lens) connected to the frame 100.

Moreover, the optical device 200, as described below, may include a barrel 210, a light source device 220 that is arranged within the barrel and includes a light source, an optical signal generation unit 230 that converts an optical signal into a signal for an image signal, and a detection unit 250. The details provided below may apply in the same manner to descriptions of these constituent elements.

Particularly, the detection unit 250 in the optical device 200 according to the embodiment may include a light reception unit 251. In addition, the detection unit 250 may include a barrier unit 252 adjacent to the light reception unit 251 and a substrate unit 253 connected to the light reception unit. At this point, the barrel 210 in the optical device 200 may include a through-hole 210rs formed on the lateral side.

At this point, the detection unit 250 may be arranged adjacent to the through-hole 210rs. Accordingly, light passing through a plurality of lenses within the barrel 210 may be emitted to the outside through the through-hole 210rs. For example, in a case where the user (or wearer) wears the electronic device, the light emitted through the through-hole 210rs may be emitted to the wearer's skin. Light IL that is emitted may pass through the wearer's tissue and propagate into the vessel. At this point, the amount of absorbed light varies depending on the amount of blood (for example, red blood cells) flowing through the vessel (for example, the artery). For example, the amount of blood passing through the vessel increases or decreases alternately depending on the periodicity or frequency of the cardiac impulse (or the pulse). For example, when the amount of blood is large, most of the light (for example, light at a green wavelength) propagating into the skin is absorbed into the red blood cells. Thus, the amount of light reflected out of the skin may be relatively decreased. Accordingly, the light received by the light reception unit 251 may be relatively decreased. Otherwise, when the amount of blood is small, the light propagating into the skin is absorbed into the red blood cells. Thus, the amount of light reflected out of the skin may be relatively increased. Accordingly, the light received by the light reception unit may be relatively increased. In other words, the amount of light received by the light reception unit may be smaller in the case where the amount of blood is large than in the case where the amount of blood is small. The light reception unit 251 may convert the received light into an electric signal, and the electrical signal, resulting from the conversion, may be transmitted to a control unit of the optical device or a control unit of the electronic device. Therefore, the wearer's pulse may be detected through the detection unit 250. Accordingly, the electronic device or the optical device may detect whether or not the user wears the electronic device, using the detection unit 250.

The barrier unit 252 may be arranged adjacent to the light reception unit 251 and thus may inhibit the light passing through the through-hole 210rs from propagating directly to the light reception unit 251. Accordingly, the optical device or electronic device according to the embodiment may perform sensing in a more accurate manner. For example, the optical device or electronic device may accurately detect the pulse or the oxygen saturation level.

The substrate unit 253 may support the barrier unit 252 and the light reception unit 251. Moreover, the substrate unit 253 may be electrically connected to the light reception unit 251 and may be electrically connected to the control unit of either the optical device or the electronic device.

Further with reference to FIGS. 8 to 11, an optical device 200 according to an embodiment include a barrel 210, a lens L, and a first light guide LG1. Moreover, the optical device 200 may include a light source device 220 that is positioned in or coupled to an opening portion OP formed in a lateral surface of the barrel 210, and an optical signal generation unit 230 adjacent to the barrel 210. Moreover, the optical device 200 may further include a cover CV, which covers the barrel 210, the light source device 220, and the optical signal generation unit 230, and a substrate (not illustrated) that includes a connector.

The lens L may include a plurality of lenses. For example, the lens L may include a plurality of lenses arranged sequentially from the top of the barrel 210. For example, the lens L may include a first lens L1, which is arranged at the uppermost position, a second lens L2, which is arranged underneath the first lens L1, and so forth up to an N-th lens Ln, which is arranged at the lowermost position. At this point, N may be a natural number that is greater than or equal to 2. Among the plurality of lenses L, the N-th lens Ln may be positioned closest to the optical signal generation unit 230, which is positioned under the lower end of the barrel 210 or under the lowermost lens of the plurality of lenses L.

In addition, in an embodiment of the present invention, a first direction (the X-axis direction) may correspond to the optical axis. In addition, the first direction (the X-axis direction) may correspond to a direction in which light that is emitted from the light source device 220 and reflected from the optical signal generation unit 230 is emitted to the above-described display unit. A second direction (the Y-axis direction) is a direction perpendicular to the first direction (the Y-axis direction). Moreover, the second direction (the Y-axis direction) may correspond to the direction from the first light guide LG1 toward the opening portion OP. In addition, hereinafter in the present specification, or in the present embodiment, the second direction (the Y-axis direction) may correspond to the direction from the first light guide LG1 toward a second light guide LG2. The first light guide LG1 may be referred to as a first light guide unit or a first guide member. In addition, the second light guide LG2 may be referred to as a second light guide unit or a second guide member.

The barrel 210 may further have a hole corresponding to the opening portion OP. As an embodiment, the barrel 210 may have a barrel hole or an additional hole 210h. An additional hole 210h may be positioned in a manner that faces the opening portion OP. Alternatively, the additional hole 210h may overlap with the opening portion OP in the second direction (the Y-axis direction). Alternatively, the distance in the first direction from the N-th lens Ln to the additional hole 210h may be the same as the distance between the opening portion OP and the N-th lens Ln. Alternatively, the additional hole 210h may be positioned in a region, corresponding to the position of the opening portion OP, of the internal surface of the barrel 210. With this configuration, a joining member may be easily applied to the light source device 220 that is coupled to, inserted into, fixed to, or connected to, the opening portion OP through the additional hole 210h. Accordingly, the binding force between the barrel 210 and the light source device 220 may be enhanced. Therefore, the optical device 200 according to the embodiment may have durability, endurance, or reliability that is enhanced. Alternatively, optical tests may also be easily performed on the light source device 220, positioned in the opening portion OP, through the additional hole 210h. Alternatively, fluid (for example, air) discharge or dispensing through the additional hole 210h may be easily performed on the barrel 210 and the light source device 200 through the additional hole 210h. The presence or absence of the additional hole 210h may apply in a manner that varies from one embodiment to another. For example, the additional hole 210h, as described above, may be arranged on the lateral surface of the barrel 210. Alternatively, the additional hole 210h may not be present on the lateral surface of the barrel 210, considering durability or similar factors.

A plurality of lenses L may be positioned within the barrel 210. In addition, the first light guide LG1 may be positioned within the barrel 210.

The barrel 210 according to an embodiment may include the opening portion OP formed in the lateral surface thereof. The opening portion OP may have various shapes, such as a circle and a polygon. The opening portion OP may correspond to the position of the first light guide LG1.

As an embodiment, the opening portion OP may overlap with the first light guide LG1 in the direction perpendicular to the optical axis. With this configuration, light emitted from the light source device 220 positioned on a lateral portion of the barrel 210 may be easily incident on the first light guide LG1.

The first light guide LG1 may be arranged between two lenses of the plurality of lenses. For example, the first light guide LG1 may be arranged between the first lens L1 and the N-th lens Ln. In addition, the first light guide LG1 may be arranged between the first lens L1 and the optical signal generation unit 230. In addition, the first light guide LG1 may be arranged between the first lens L1 and the second lens L2 or between the second lens L2 and the N-th lens Ln. In various embodiments, these various positions of the first light guide LG1 are described below.

In the present embodiment, the first light guide LG1 may be positioned between the second lens L2 and the N-th lens Ln. Accordingly, the N-th lens Ln may be arranged between the first light guide LG1 and the optical signal generation unit 230. With this configuration, light reflected from the first light guide LG1 may be provided to the optical signal generation unit 230, thereby securing a suitable light path. In addition, refraction of the reflected light may be achieved. Accordingly, minimization of the first light guide LG1 may be achieved.

The first light guide LG1 may include a first prism. The first prism may be a polarizing prism. In addition, the first prism may be a polarized separation prism.

The first prism may reflect first polarized light and transmit a second polarized light. For example, a portion (the first polarized light) of light provided from the light source device 220 or incident on the first light guide LG1 may be reflected from the first light guide LG1 and be provided to the optical signal generation unit 230. Another portion (the second polarized light) of the light incident on the first light guide LG1 may pass through the first light guide LG1 and be absorbed into the barrel 210.

The light emitted from the light source device 220 through the opening portion OP may be incident on the first light guide LG1. To this end, as described above, the opening portion OP may be arranged in a region where the first light guide LG1 is positioned. For example, the incident surface of the first light guide LG1 may be positioned in a manner that faces the opening portion OP. Alternatively, the position of the first light guide LG1 in the barrel 210 may be the same as that of the first light guide LG1.

The light source device 220 may include a light source 223 and thus generate (produce or provide) light. The light source device 220 according to the embodiment may be positioned in or coupled to the opening portion OP. That is, the light source device 220 may be connected or coupled to the barrel 210.

The light source device 220 may include a housing 222 having an opening 222h, the second light guide LG2 arranged within the housing 2220, and the light source 223 that provides light to the second light guide LG2.

Moreover, the light source device 220 may include a light source assembly 221 that is arranged on the outer side of the light source device 220 and covers the housing 222, a light source lens 224 adjacent to the light source 223, and a medium lens MO positioned within the housing 222.

The light source assembly 221 may be arranged at the outermost edge of the light source device 220. In a case where the light source 223 is difficult to mount within the housing 222 or where it is necessary to mount an additional lens (a light source lens), the light source assembly 221 may be positioned outside the housing 222. The light source assembly 221 may have a structure that is integrally formed with the housing 222 or separated from the housing 222.

The housing 222 may have the opening 222h. The housing 222 may be positioned adjacent to the opening portion OP in the barrel 210. For example, the opening 222h in the housing 222 may be positioned in a manner that corresponds to the opening portion OP in the barrel 210. Accordingly, the opening 222h in the housing 222 may overlap with the opening portion OP in the barrel 210 in the second direction (the Y-axis direction).

The light source 223 may be positioned within either the housing 222 or the light source assembly 221. The light source 223 may emit light. For example, the light from the light source 223 may be incident on the second light guide LG2 within the housing 222. The second light guide LG2 may be positioned within the housing 222. Accordingly, the second light guide LG2 may transfer the light emitted from the light source 223 to either the opening 222h or the first light guide LG1.

The light source 223 may include one or more light sources. That is, in the light source device 220, the light source 223 may refer to a single light source and include a plurality of light sources. The light source 223 may include a plurality of light sources, for example, a first light source 223a, a second light source 223b, and a third light source 223c. The first to third light sources 223a to 223c may emit light in the same direction or in different directions. For example, the first light source 223a and the third light source 223c may be positioned in a manner that faces each other. The first light source 223a and the third light source 223c may be positioned in a manner that overlaps with each other in the first direction (the X-axis direction). The second light guide LG2 may be positioned between the first light source 223a and the third light source 223c. Accordingly, the second light guide LG2 may overlap with the first light source 223a and the third light source 223c. The second light source 223b may be positioned between the first light source 223a and the third light source 223c. The first to third light sources 223a to 223c may emit light toward the second light guide LG2. The second light source 223b may overlap with the second light guide LG2 in the second direction. With this configuration, the optical device 200 may have the compact light source device 220.

In addition, the first light source 223a, the second light source 223b, and the third light source 223c may emit light at the same wavelength or color, or emit light at different wavelengths or in different colors. For example, the first light source 223a, the second light source 223b, and the third light source 223c may emit red, green, and blue light, respectively.

The second light guide LG2 may include a second prism. The second prism serves as a reflection member and may include, for example, an X-prism. As an embodiment, the second light guide LG2 or the second prism may have a structure in which at least two prisms are coupled to each other.

The second prism may have at least two coated surfaces (reflection members or reflection sheets). One of the at least two coated surfaces may reflect light at a first wavelength and light at a second wavelength and transmit light at a third wavelength. That is, the coated surface may reflect light in a predetermined wavelength band. Accordingly, the light in a desired wavelength band, which is emitted from each of the plurality of light sources 223, may be reflected from the second light guide LG2. For example, the light passing through the second light guide LG2 may be provided to the first light guide LG1 or the medium lens MO.

The light source lens 224 may be positioned adjacent to the light source 223. For example, the light source lens 224 may include a plurality of light source lenses. The light source lens 224 may be positioned on a path of light emitted from each light source 223.

As an embodiment, the light source lens 224 may be positioned between the second light guide LG2 and the light source 223. In addition, the light source lenses 224 may include a plurality of light source lenses. The plurality of light source lenses 224 may be positioned between the second light guide LG2 and the light source 223. Alternatively, the light source lens 224 may be provided in such a manner as to correspond to the plurality of light sources 223, respectively.

For example, the light source lens 224 may include a first light source lens 224a, a second light source lens 224b, and a third light source lens 224c. The first light source lens 224a may be positioned between the first light source 223a and the second light guide LG2. The second light source lens 224b may be positioned between the second light source 223b and the second light guide LG2. The third light source lens 224c may be positioned between the third light source 223c and the second light guide LG2.

In addition, the plurality of light source lenses, for example, the first light source lenses 224a, the second light source lenses 224b, and the third light source lenses 224c may be positioned over the plurality of light sources, for example, the first light source 223a, the second light source 223b, and the third light source 223c, respectively. For example, any one of the plurality of first light source lenses 224a may be positioned over the first light source 223a and coupled to the light source assembly 221. Another one of the plurality of first light source lenses 224a may be positioned between the previously mentioned first light source lens 224a and the second light guide LG2 and coupled to the housing 222.

The first light source lens 224a, the second light source lens 224b, and the third light source lens 224c may include a collimation lens or a collimator.

In addition, a substrate 225 connected to the light source 223 may be arranged in the light source assembly 221. The substrate 225 may refer to a single substrate or include a plurality of substrates in a manner that corresponds to the light source 223. For example, a plurality of substrates 225 may include a first substrate 225a, a second substrate 225b, and a third substrate 225c. As described above, the plurality of substrates 225 may either form a single integrated substrate or correspond to the number of the light sources.

In addition, the substrate 225 may be electrically connected to a control unit or a processor within the above-described frame (or display unit). Accordingly, the substrate 225 may include a connector for communicating with either an external apparatus or a connected apparatus. Moreover, the substrate 225 may be arranged outside the light source 223 and dissipate heat generated in the light source to the outside. Accordingly, the reliability of the light source device 220 can be enhanced.

The medium lens MO may be positioned between the opening 222h and the second light guide LG2. In addition, the medium lens MO may be positioned between the first light guide LG1 and the second light guide LG2.

The medium lens MO may include a plurality of lenses. For example, the medium lens MO may include a first medium lens MO1 and a second medium lens MO2. However, as described below, without the medium lens MO, the light reflected from the second light guide LG2 may also be provided directly to the first light guide LG1.

The first medium lens MO1 may have a first surface MO1s1 adjacent to the first light guide LG1 and a second surface MO1s2 corresponding to the first surface MO1s1. The light emitted from the light source 223 may pass through the second light guide LG2 and then sequentially pass through the first surface MO1s1 and the second surface MO1s2.

The second surface MO1s2 may be convex toward the second light guide LG2. Alternatively, the second surface MO1s2 may be concave toward the first light guide LG1. Moreover, the first surface MO1s1 may be either convex or concave toward the second light guide LG2. For example, the first medium lens MO1 may have the shape of a meniscus. Since the second surface MO1s2 is convex toward the second light guide LG2 in this manner, light may converge while passing through the medium lens MO. Accordingly, the regularity or uniformity of the light provided to the optical signal generation unit 230 can be improved. In other words, the light incident on the optical signal generation unit 230 may be surface light. Then, the uniformity of the surface light can be improved. Accordingly, the accuracy or resolution of either an image signal or an image emitted to the display unit through the optical device 200 according to the embodiment can be improved.

The second medium lens MO2 may include a microlens array (MLA). Accordingly, surface-illumination may be partially performed on the light passing through the second light guide LG2.

Moreover, the second medium lens MO2 may have a different size than the second light guide LG2. In addition, the first medium lens MO1 may have a different size than the second light guide LG2. For example, the medium lens MO2 may have a greater size than the second light guide LG2.

Moreover, the positions of the plurality of lenses L, the positions of the plurality of medium lenses MO, and the positions of the plurality of light source lenses 224 may be maintained by spacers SP. For example, a plurality of spaces SP adjacent to the plurality of lenses L, respectively, may be present within the barrel 210. In addition, a plurality of spaces SP may be arranged in either the housing 222 or the light source assembly 221 of the light source device 220 in a manner that is adjacent to each of the medium lens MO and the light source lens 224. As an embodiment, the plurality of spaces SP may be arranged over or under the above-described lens and thus fix or maintain the position of the lens.

The optical signal generation unit 230 may be positioned under the lower end of the barrel 210. The optical signal generation unit 230 may overlap with the lens L either in the optical axis or in the first direction (the X-axis direction).

The optical signal generation unit 230 may convert light, which is incident on the first light guide LG1, reflected, and then passes through the N-th lens, into an optical signal including image information.

The optical signal generation unit 230 may reflect the light (the first polarized light) reflected from the first light guide LG1. The optical signal generation unit 230 may generate an optical signal including image information. That is, the light emitted from the optical signal generation unit 230 may be light including image information.

The optical signal generation unit 230 may include a liquid crystal on silicon (LCoS) device.

The liquid crystal on silicon device may have a structure in which liquid crystal is dispensed between a silicon wafer (a thin circular substrate material for semiconductors) with a Complementary Metal-Oxide semiconductor (CMOS) array, and an Anti-Reflection (AR) member coated with a transparent electrode (Indium Tin Oxide (ITO)).

An alignment layer may be formed on top of the wafer (silicon wafer), thereby forming an initial liquid crystal orientation.

Moreover, either a reflection layer or a reflection electrode that is formed as an aluminum layer and has a high optical reflectance may be positioned underneath the alignment layer. The reflection electrode may be positioned on top of the silicon wafer. A semiconductor array (CMOS array) may be formed on top of the silicon wafer. A data signal may be transmitted to this semiconductor array through a panel.

The optical signal generation unit 230 may reflect at least one portion of the incident light, depending on the driving of the optical signal generation unit 230. The optical signal generation unit 230 may reflect light incident from a surface light source on a per-pixel basis. In addition, the intensity of the reflected light may also be adjusted depending on the degree of modulation. For example, the optical signal generation unit 230 may modulate one portion of the first polarized light into the second polarized light. Accordingly, the second polarized light, resulting from the modulation, may pass through the first light guide LG1 and the first lens L1 and then be provided to the display unit.

That is, the optical signal generation unit 230 may modulate retardation of the light, resulting from the modulation, that is, the polarized light. The optical signal generation unit 230 may perform retardation of the first polarized light in various ways. That is, an electric field may be formed by adjusting voltage for each pixel (voltage of an electrode). The degree to which liquid crystal is twisted may also be adjusted depending on the adjusted voltage. For example, when a maximum voltage is applied, the light reflected from the optical signal generation unit 230 may be all reflected from the first light guide LG1. When a minimum voltage is applied, the light reflected from the optical signal generation unit 230 may all pass through the second light guide LG1. However, the light reflected from the optical signal generation unit 230 may also conversely propagate depending on the electric field. In addition, when a middle-level voltage is applied, one portion of the light may pass through the first light guide LG1. That is, the intensity (for example, the brightness) of the light provided to the display unit may be approximately at a middle level.

In this manner, an optical signal generated by the optical signal generation unit 230 may be transferred to the first lens L1 through the N-th lens Ln and the first light guide LG1. Moreover, at least one portion of the optical signal generated by the optical signal generation unit 230 may pass through the first lens L1 and be incident on the display unit.

Additionally, a transparent member 240 may be further arranged between the optical signal generation unit 230 and the N-th lens Ln (or the first light guide). The transparent member 240 may be a glass pane. The transparent member 240 may be coupled to the barrel 210 or the cover CV. Moreover, the transparent member 240 may be positioned over the optical signal generation unit 230. Accordingly, foreign material can be easily blocked from being introduced into the optical signal generation unit 230. The transparent member 240 may have the same size as or a different size than the optical signal generation unit 230. Moreover, the transparent member 240 may overlap with at least one portion of the optical signal generation unit 230 either in the optical axis or in the first direction (the X-axis direction).

In addition, a barrier unit 252 may be positioned between a through-hole 210rs in the barrel 210 and a light reception unit 251 thereof. The light reception unit 251 may be positioned in a region DA positioned between the first light guide LG1 and the optical signal generation unit 230. For example, the region DA may be a region in the first direction (first X-axis direction) between the through-hole 210rs and the optical signal generation unit 230. In addition, the through-hole 210rs may be positioned within the region DA. With this configuration, one portion of the light emitted before an optical signal is incident on the region 230 may be efficiently emitted to the outside (for example, the wearer's skin) through the through-hole 210rs. That is, increasing the amount of light passing through the through-hole 210rs can improve the sensing precision through a detection unit 250.

The light reception unit 251 may be positioned within the barrel 210. For example, the light reception unit 251 may be positioned within a groove formed in the external surface of the barrel 210. In addition, the external surface of the light reception unit 251 and the external surface of the barrel 210 may be stepped. For example, the light reception unit 251 may protrude farther outward than external surface of the barrel 210. Accordingly, the light reception unit 251 may be arranged in a manner that is closer to the user. Therefore, the sensing precision may be further improved through the light reception unit 251.

Likewise, the barrier unit 252 may protrude farther outward than the external surface of the barrel 210. Accordingly, the barrier unit 252 can inhibit the phenomenon where the light emitted through the through-hole 210rs is emitted directly to the light reception unit 251. That is, noise can be reduced.

Moreover, in the optical device according to the embodiment, among the plurality of lenses, a first reference lens Lₙ and a second reference lens Lₙ₋₁ may be positioned in a manner that is sequentially adjacent to the optical signal generation unit 230. The second reference lens, although not illustrated, may be positioned between the first light guide LG1 and the first reference Lₙ. The size d2 of the first reference Lₙ may be greater than the size d1 of the second reference lens Lₙ₋₁. At this point, the through-hole 210rs may be positioned between the first reference lens Lₙ and the second reference lens Lₙ₋₁. Accordingly, light may be more easily emitted from the first reference lens toward the second reference lens through the through-hole 210rs. Accordingly, the precision of the detection unit can be improved. Likewise, the light reception unit 251 may also be positioned between the first reference lens Lₙ and the second reference lens Lₙ₋₁.

Further with reference to FIG. 12, light La, Lb, and Lc emitted from the light sources 223, respectively, may pass through the light source lens 224, the second light guide LG2, and the medium lens MO. For example, first light La, second light Lb, and third light Lc, which are emitted from first to third light sources 223a to 223b, respectively, may be emitted from the second light guide LG2 in the same direction.

For example, the second light guide LG2 may have a first coated surface LG2a and a second coated surface LG2b. As described above, one of at least these two coated surfaces may reflect one or more of the following: light at a first wavelength, light at a second wavelength, or light at a third wavelength. For example, the first wavelength includes in a wavelength band of red light. The second wavelength includes in a wavelength band of green light. The third wavelength includes in a wavelength band of blue light.

In addition, the first coated surface LG2a may reflect the first light La or light at the first wavelength. That is, the first coated surface LG2a may transmit the second light Lb and the third light Lc. In other words, the first coated surface LG2a may transmit light at the second wavelength and light at the third wavelength.

The second coated surface LG2b may reflect the second light Lb or the light at the second wavelength. That is, the second coated surface LG2b may transmit the first light La and the third light Lc. In other words, the second coated surface LG2b may transmit the light at the first wavelength and the light at the third wavelength.

Accordingly, the first light La may be reflected from the second light guide LG2 in a manner that propagates toward, or incident on, the medium lens MO or the opening portion OP. The second light Lb may be reflected from the second light guide LG2 in a manner that propagates toward, or incident on, the medium lens MO or the opening portion OP. In addition, the third light Lc may be reflected from the second light guide LG2 in a manner that propagates toward, or incident on, the medium lens MO or the opening portion OP.

Accordingly, light IL (or indicated by a combination of La, Lb, and Lc) emitted from the light source 223 may be incident on the first light guide LG. At this point, light that is incident on the first light guide LG may be first incident light IL.

Further with reference to FIG. 13, some of the first incident light IL may be reflected from the first light guide LG1, and the rest may pass through the first light guide LG1. That is, the first light guide LG1 may reflect first polarized light Ila of the first incident light IL and transmit second polarized light ILb thereof. For example, the first polarized light ILa and the second polarized light ILb may each be either S-polarized or P-polarized light. Accordingly, the first polarized light ILa that is one portion of the first incident light IL may be provided to the optical signal generation unit 230 through the N-th lens Ln. The second polarized light ILb may be absorbed into the barrel 210 or be provided to the additional hole 210h.

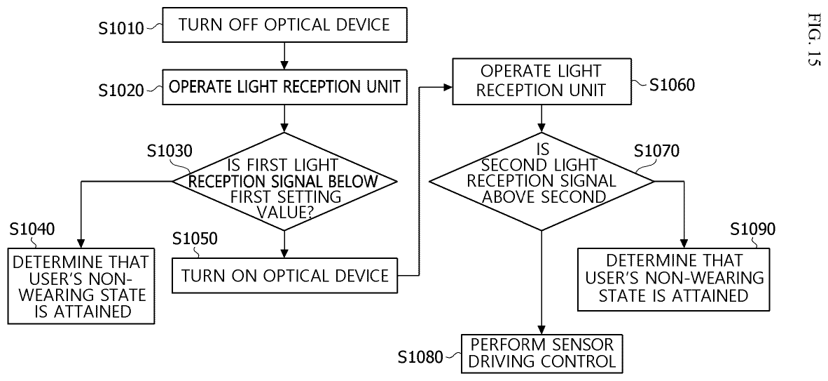

FIG. 14 is a view illustrating another example of the light source device according to the embodiment.

With reference to FIG. 14, the light source 223 in the light source device 220 may be at least a single light source as described above. That is, the light source 223 may include a first light source 223a, a second light source 223b, and a third light source 223c. Furthermore, in another example, instead of the second light guide, a plurality of mirrors (for example, mirrors M1 to M3) are present. That is, the optical device may include a plurality of mirrors (for example, mirrors M1 to M3), and light may be provided to a plurality of lenses or the first light guide using the plurality of mirrors (for example, the mirrors M1 to M3). Other optical devices may have various structures.

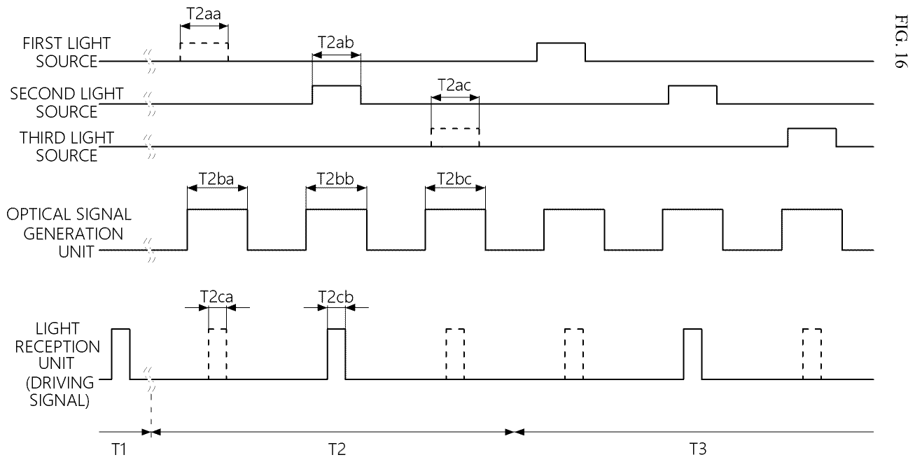

FIG. 15 is a flowchart illustrating a method of operation of either the electronic device according to the embodiment or the optical device thereof. FIG. 16 is a timing chart that is referenced to describe respective operations of the light source, the optical signal generation unit, and the light reception unit.

First, the light reception unit 251 may operate while light is emitted from the light source. However, as described below, in detecting whether or not the electronic device is worn, the light reception unit 251 may not operate while light is not emitted from the light source. In addition, the method of operation, which is described below, may be executed by a control unit (or controller) of the optical device or the control unit (or controller) of the electronic device. That is, except for the details described below, processing in each step of a method of operation, which is described below, may be performed by the control unit. The method of operation according to the disclosed embodiment may be implemented in the form of program commands executable by various computer apparatuses and thus be recorded on a computer-readable medium. In addition, the embodiment of the present disclosure may be a computer-readable recording medium on which one or more programs containing commands executing the method of operation.

With reference to FIGS. 15 and 16, the method of operation according to the embodiment includes: Step S1010 of turning off the optical device; Step S1020 of operating the light reception unit; Step S1030 of comparing a first light reception signal with a first setting value; Step S1050 of turning on the light source device; Step S1060 of operating the light reception unit; Step S1070 of comparing a second light reception signal with a second setting value, and Step S1080 of driving the detection unit.

At this point, to operate (for example, turn on) the light source unit, the control unit may transmit a HIGH signal to the light reception unit. That is, the control unit may control operation of the light reception unit. In addition, the control unit may control the turning-on (HIGH state) or turning-off (LOW state) of the light source. In addition, the control unit may control the turning-on or turning-off of the optical signal generation unit by controlling the turning-on or turning-off of the light source. In other words, the control unit may control the light source device, the optical signal generation unit, and the light reception unit.

First, when the electronic device is powered on, the control unit may keep the light source turned off. That is, electric current may not be applied to the light source. For example, in a first operation section T1, as described above, in a case where the optical device is turned off, the control unit may operate the light reception unit (enable the light receiving unit to enter the HIGH state) (S1020). In the first operation section T1, the control unit may receive the first light reception signal from the light reception unit. In other words, in a case where electric current is not applied to the light source device (a LOW state is entered), the control unit may enable the light reception unit to operate and receive the first light reception signal from the light reception unit. In the first operation section T1, the control unit may compare the first light reception signal with the first setting value (S1030).

The control unit may determine by comparing the first light reception signal with the first setting value whether or not to drive the light source device. At this point, in a case where the first light reception signal is at or above the first setting value, the control unit may determine that the user's non-wearing state in which ambient light is not introduced is attained. Accordingly, the control unit may output a non-wearing alarm or the like and return to Step S1010 described above. Moreover, the control unit may start again from Step S1020.

In the first operation section T1, in a case where the first light reception signal is below the first setting value, proceeding to a second operation section T2 may take place.

In the second operation section T2, the control unit may transmit the HIGH signal to the light source device. As an embodiment, the control unit may transmit the HIGH signal to a light source (for example, the second light source emitting light at a green wavelength) in the light source device. For example, the control unit may transmit the HIGH signal at least one of the light sources in the light source device. Accordingly, the first to third light sources may emit different light or light in a non-overlapping manner. Accordingly, energy efficiency can be improved.

For example, during a first light source time section T2aa, the first light source may be turned on. In other words, during the first light source time section T2aa, the control unit may transmit the HIGH signal to the first light source. In addition, during a first generation unit time section T2ba, the optical signal generation unit may be turned by receiving the HIGH signal. Moreover, during a first light reception time section T2ca, the control unit may be turned on by receiving the HIGH signal. For example, the light reception unit may receive red light, and the control unit may detect the user's oxygen saturation level, using the optical signal (the second light reception signal) received from the light reception unit. In other words, in a case where the first light reception signal is below the first setting value, the control unit may drive the light source and receive the second light reception signal from the light reception unit.

In addition, during a second light source time section T2ab, the second light source may be turned on. In other words, during the second light source time section T2ab, the control unit may transmit the HIGH signal to the second light source. In addition, during a second generation unit time section T2bb, the optical signal generation unit may be turned on by receiving the HIGH signal. Moreover, during a second light reception time section T2cb, the control unit may be turned on by receiving the HIGH signal. For example, the light reception unit may receive green light, and the control unit may detect the user's pulse, using the optical signal (the second light reception signal) received from the light reception unit.

In addition, during a third light source time section T2ac, the third light source may be turned on. In other words, during the third light source time section T2ac, the control unit may transmit the HIGH signal to the third light source. In addition, during a third generation unit time section T2bc, the optical signal generation unit may be turned on by receiving the HIGH signal. Moreover, during a third light reception time section T2cc, the control unit may also be turned off by receiving a LOW signal.

For example, the light source time section and the generation unit time section may be synchronized to each other.

In this manner, in the second operation section T2, the control unit may detect or determine whether or not the user is in a wearing state, using the optical signal (the second light reception signal) received from the light reception unit. In addition, only in a case where a specific light source is turned on (in the HIGH state), the control unit may receive the optical signal (the second light reception signal) by driving the light reception unit.

In addition, in the present embodiment, in a case where the light source is turned on (in the HIGH state), the optical signal generation unit may be turned on (in the HIGH state) in a manner that corresponds to the light source time section. Accordingly, an operational accuracy level can be improved.

Subsequently, the control unit may receive the second light reception signal that is output by the light reception unit that is turned on (S1060). The control unit may compare the second light reception signal with the second setting value (S1070). At this point, when the second light reception signal is below the second setting value, the control unit may determine that the user or wearer is not accurately in the wearing state. For example, in a case where at least one portion of the electronic device comes appropriately in close contact with the skin, the second light reception signal may be below the second setting value. Accordingly, it may be determined whether or not the user is accurately in the wearing state. In this case, it may be determined that the user is in the non-wearing state or particularly in an improper wearing state, and thus a waiting state may be entered (S1090). For example, returning to Step S1010 or Step S1050 may take place.

Conversely, in a case where the second light reception signal is above the second setting value, proceeding to a third operation section T3 may take place. Accordingly, the control unit may transmit, with a predetermined period, a driving signal (the HIGH signal) to the light source and the optical signal generation unit.

The control unit may turn on the light reception unit (enable the light reception unit to enter the HIGH state) in a manner that corresponds to the turning-on (the HIGH states) of the light source and the optical signal generation (S1080). In other words, the control unit may compare the second light reception signal with the second setting value and accordingly receive a third light reception signal from the light reception unit in a manner that corresponds to respective operations of the light source and the optical signal generation unit. That is, the control unit may drive the detection unit (S1080). For example, in order to detect the wearer's pulse in the third operation section T3, the control unit may, with a predetermined period, turn on the light reception unit for operation (enable the light reception unit to enter the HIGH state) in a manner that corresponds to the turning-on of the light source and the optical signal generation unit (corresponds to, for example, the second light source time section and the second generation unit time section).

For example, in order to detect the wearer's oxygen saturation level in the third operation section T3, the control unit may, with a predetermined period, turn on the light reception unit for operation (enable the light reception unit to enter the HIGH state) in a manner that corresponds to the turning-on of the light source and the optical signal generation unit (corresponds to, for example, the first light source time section and the first generation unit time section).

In the method of operation and the electronic device according to the various embodiments described above, a test image may be selected for each of the user's right and left eyes. In addition, the test image may also be selected for both of the user's eyes. Alternatively, the test image may also be selected sequentially for the user's right, left eye, and both eyes.

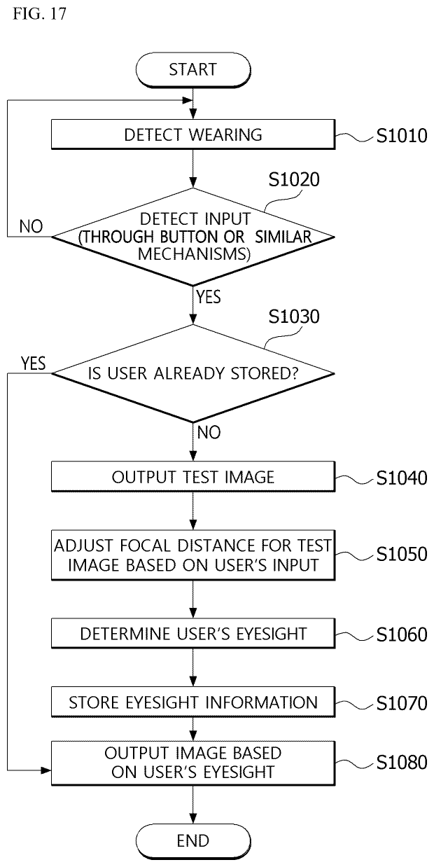

First, a method of display, which is described with reference to FIGS. 17 to 24, may be executed by the control unit of the electronic device described above. That is, except for the details described below, processing in each step of a method of display, which is described below, may be performed by the control unit. The method of display according to the disclosed embodiment may be implemented in the form of program commands executable by various computer apparatuses and thus be recorded on a computer-readable medium. In addition, the embodiment of the present disclosure may be a computer-readable recording medium on which one or more programs containing commands executing the method of display.

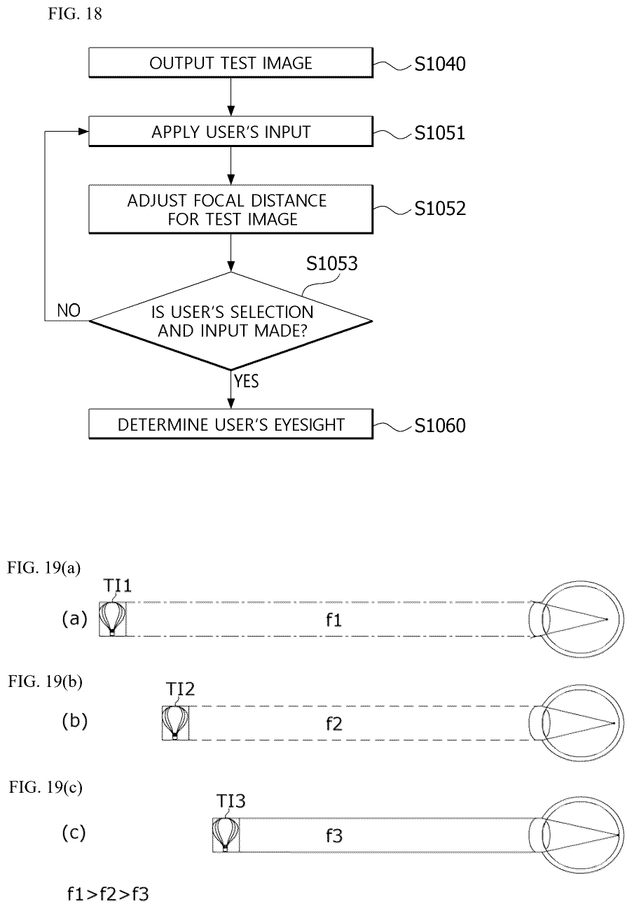

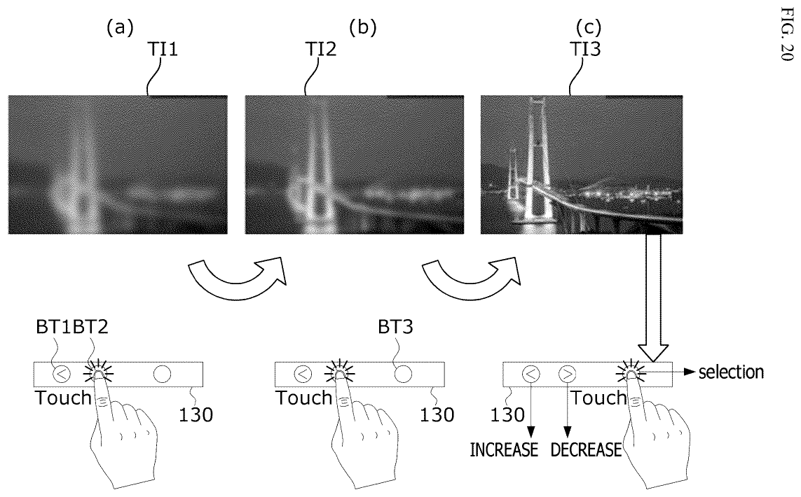

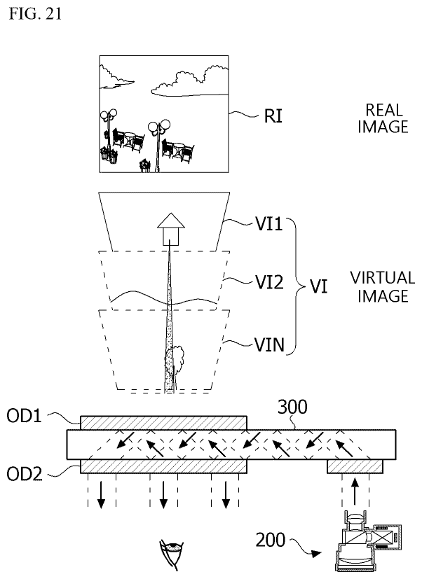

FIG. 17 is a flowchart illustrating a method of display according to an embodiment. FIG. 18 is an additional flowchart illustrating the method of display according to the embodiment. FIGS. 19(a)-20 are views that are referenced to describe determination of eyesight in the method of display according to the embodiment. FIG. 21 is a view illustrating the output of an image in the method of display according to the embodiment.

With reference to FIGS. 17 and 18, the method of display according to the embodiment includes: Step S1040 of outputting test images with different focus lengths; Step S1060 of determining a user's eyesight using as a reference a test image selected from among the test images with different focal distances; and Step S1080 of outputting a virtual image based on the user's determined eyesight.

Moreover, the method of display according to the embodiment, before Step S1040 of outputting test images with different focal distances, may further include: Step S1010 of detecting a user (or a wearer of an electronic device); Step S1020 of checking whether or not an input (through a button or similar mechanisms) is detected; and Step S1030 of checking whether or not the user is already stored, when the input is detected.

Preferentially, with reference to FIG. 2, in a case where the user or the wearer wears a display device, the control unit 27 (refer to FIG. 2) may detect or determine whether or not the user wears the display device, using a detection signal received through the sensing unit 23 (refer to FIG. 2). When the user wears the display device, the control unit 27 may determine whether or not an input is detected, based on a signal received by the sensing unit 23 (S1020). For example, the user can generate an input signal through the user input unit 130 (refer to FIG. 3) or the input unit 22 (refer to FIG. 2). When the user touches the input unit, it may be recognized that the user uses the electronic device. In a case where the user's input is not detected within a predetermined time, the control unit may re-perform the step of detecting whether or not the user wears the electronic device.

Moreover, when an input is detected through the input unit, the control unit may check whether the user is already stored (S1030). In a case where the user is already stored, the control unit may retrieve the user's eyesight information stored in the memory 26 (in FIG. 2). Alternatively, depending on the user's input, although the user is already stored, the control unit may re-determine the user's eyesight and re-store the user's eyesight information. Accordingly, any changes in the user's body may also be easily taken into consideration.

In a case where the user is not already stored or where the user is tested again, as described above, the control unit may output text images with different focal distances (S1040). For example, the control unit may generate or provide image signals for the test images with different focal distances. Based on the image signals for the test images, which are generated by the control unit, the optical device may generate images, and the images generated by the optical device may be output on the display unit.

Further with reference to FIGS. 19(a)-19(c), test images TI1, TI2, and TI3 may have different focal distances. A plurality of test images, for example, the test images TI1, T12, and T13 may be provided. As an embodiment, the test images may include a first test image TI1, a second test image TI2, and a third test image TI3. At this point, the first test image TI1 has the longest focal distance from the user's eyeball, followed by the second test image TI2, and then by the third test image TI3. For example, a focal distance f1 of the first test image TI1 may be greater than a focal distance f2 of the second test image TI2. The focal distance f2 of the second test image TI2 may be greater than a focal distance f3 of the third test image TI3.

Further with reference to FIG. 20, the first test image TI1, the second test image T12, and the third test image TI3 are described as being the same as the test image in FIGS. 19(a)-19(c). Moreover, the first test image TI1, the second test image TI2, and the third test image TI3 may be output depending on the user's selection (input) (S1051). One of the plurality of test images may be output by the control unit. For example, the control unit may output the first test image TI1. Subsequently, the user can input the input signal by touching or otherwise interaction with the input unit 130 (S1051). For example, the user can generate the input signal by touching one of the following: a first button BT1, a second button BT2, or a third button BT3, on the input unit arranged on the frame. At this point, the first button BT1 may correspond to an increase in the focal distance for the test image. The second button BT2 may correspond to a decrease in the focal distance for the test image. The third button BT3 may correspond to the selection of the test image. Moreover, like in the case where the first test image TI1, the second test image TI2, and the third test image TI3, have different focal distances, one or more test images may have different focal distances. Moreover, in a case where a plurality of test images with different focal distances are provided, the plurality of test images may have respective different focal distances.

As an example, when the control unit receives the user's input (S1051), the control unit may adjust the focal distance for the test image in a manner that corresponds to the user's input, that is, an applied input (S1052). The control unit may determine the user's eyesight in a manner that corresponds to the user's selection and input (S1053 and S1060).

For example, in a case where the first test image T1 is recognized in a blurred manner, the user can change the focal distance for the test image by touching the first button BT1 or the second button BT2. For example, when the user touches the second button BT2, the control unit may output the second test image TI2 that has a shorter focal distance than the first test image TI1. In a case where the second test image TI2 is recognized in a blurred manner, the user can decrease the focal distance for the test image by touching the second button BT2 again. Accordingly, the control unit may output the third test image TI3 that has a smaller focal distance than the second test image TI2. Subsequently, in a case where the third test image TI3 is recognized clearly, the user can select the third test image TI3 as an image for determining the user's eyesight by touching the third button BT3. In this manner, the control unit adjust the focal distance for the test image in a manner that corresponds to the user's input (S1050).

At this point, the image or test image selected by the user's input may be at least one of a plurality of test images. For example, a plurality of test images that are seen clearly depending on the user's eyesight may be provided. In this case, if a plurality of images are selected, the control unit may determine the user's eyesight based on the maximum focal distance. Accordingly, the control unit may determine the user's accurate eyesight and output a virtual image corresponding to the user's eyesight. Accordingly, the electronic device according to the embodiment can effectively eliminate the user's inconvenience.

The control unit may determine the user's eyesight using as a reference an image selected through the input unit (S1060). The control unit may determine the user's eyesight and then adjust a focal distance for the image based on the user's determined eyesight, thereby outputting the resulting image (S1080). Accordingly, the user can clearly recognize the virtual image output from the optical unit.

Further with reference to FIG. 21, the control unit may transmit a control signal to the optical device in such a manner that a plurality of virtual images, for example, virtual images VI, VI2, and so forth up to VIN (collectively referred to as a virtual image VI) are output. Accordingly, the optical device may generate an image corresponding to the plurality of virtual images.

As illustrated, the plurality of virtual images may be configured as layers that vary depending on distance. A virtual object may be positioned across virtual images configured as varying layers. These virtual images are transferred by the optical device 200 to the user. The user can adjust the focal distance for the virtual images based on the user's determined eyesight. For example, a plurality of virtual images may be output by reducing the focal distance for the shortsighted user.

Moreover, optical elements OD1 and OD2 may be arranged on the front and rear sides, respectively, of the display unit 300. At this point, the front side refers to the side, facing an object or a real image, of the display unit 300, and the rear side refers to the side, facing the user, of the display unit 300. Alternatively, the display unit 300 may further include the optical elements OD1 and OD2. The optical elements OD1 and OD2 may be positioned on the frame of the electronic device. In addition to the diffractive portion, the optical elements OD1 and OD may have a variable focusing lens. Accordingly, a curvature of the optical element may be changed in a manner that corresponds to the user's determined eyesight. That is, the focal distance may be changed.

For example, a first optical element OD1 may be arranged on the outside of the display unit 300 and include a diffractive portion or a polarization portion. Accordingly, a real image RI may be provided, with a predetermined frame period or through a predetermined frame, to the user. The focus or curvature of the first optical element OD1, as described above, may be changed in a manner that corresponds to the user's determined eyesight. Accordingly, the user can recognize the real image or clearly rather than in a blurred manner. That is, the real image or the like may appear on the user's eyeball as it would with normal eyesight.

Moreover, the focus or curvature of a second optical element OD2 may also be changed in a manner that corresponds to the user's eyesight.

As a modification example, a plurality of lenses are present within the optical device 200, and the distance between each of the plurality of lenses within the optical device may also be changed by an actuator or the like. Moreover, the control unit may adjust the focal distance for the test image by moving a lens within the optical device.

After determining the user's eyesight (S1060), the control unit may store eyesight information in the memory (S1070). In addition to the eyesight information, the user's specific detection information acquired through the sensing unit may also be stored together in the memory.

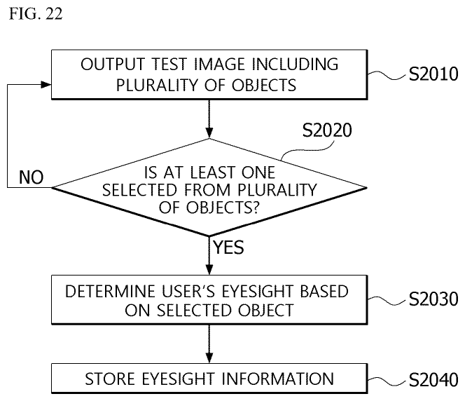

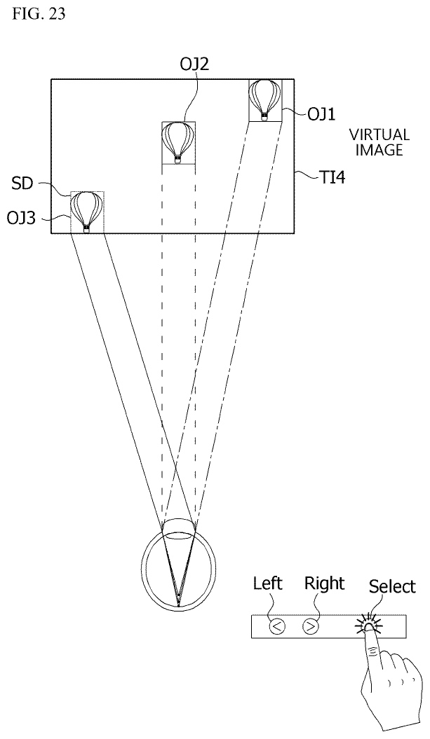

FIG. 22 is a flowchart illustrating a method of display according to another embodiment. FIG. 23 is a view that is referenced to describe eyesight determination in the method of display to the same embodiment.

With reference to FIGS. 22 and 23, the method of display according to the same embodiment may include: Step S2010 of outputting a test image including a plurality of objects; Step S2020 of selecting at least one from among the plurality of objects; Step S2030 of determining a user's eyesight based on the selected object; and Step S2040 of storing eyesight information.

Step S2010 of outputting a test image including a plurality of objects may correspond to Step S1040 of outputting test image. Moreover, the steps prior to Step S1040 of outputting test image apply to the method of display according to the present embodiment. Except for the details described below, the above-described details in each step may apply in the same manner to the method of display according to the present embodiment.

According to the present embodiment, the test image may include a plurality of objects. At this point, the plurality of objects may have different focal distances. That is, the test images with different focal distances may each include a plurality of objects with different focal distances.

As illustrated, a plurality of objects, for example, objects OJ1 to OJ3, may be included in a test image TI4. For example, the plurality of objects may include a first object OJ1, a second OJ2, and a third object OJ3. At this point, the first object OJ1 may have a greater distance or focal distance than the second object OJ2. The second object OJ2 may have a greater distance or focal distance than the third object OJ3.

For example, a selection window SD for an object within the test image, that is a virtual image, may move in a manner that corresponds to the user's input (through the first button, the second button, or the third button). For example, the first button may correspond to the left. The second button may correspond to the right. The third button may correspond to ‘select.’ One of the plurality of objects may be selected depending on the user's input. Alternatively, one test image may be selected from among the test images with different focal distances, which are configured with a plurality of layers. Accordingly, the user's eyesight may be determined. Subsequently, as described above, the user's determined eyesight may be stored. Alternatively, based on the user's determined eyesight, the focal distance for the virtual image may be adjusted and output. That is, in a case where the virtual image is output, the focus of the virtual image may be varied or changed based on the user's determined eyesight.

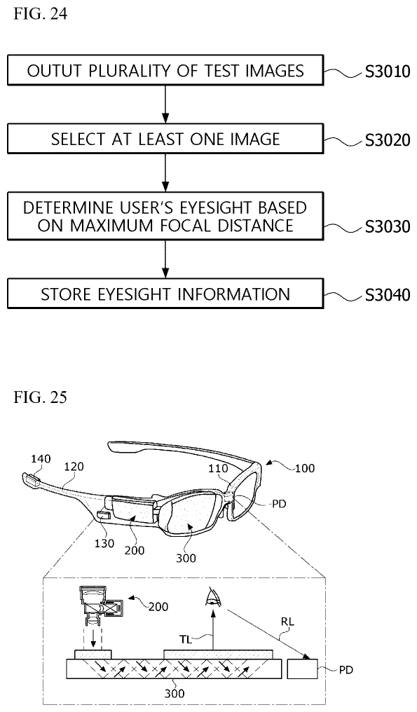

FIG. 24 is a flowchart illustrating a method of display according to a still another embodiment. FIG. 25 is a perspective view illustrating an augmented reality electronic device, as a modification example, according to an embodiment.

With reference to FIG. 24, the method of display according to the same embodiment may include: Step S3010 of outputting a plurality of test images; Step S3020 of selecting at least one image; Step S3030 of determining a user's eyesight, and Step S3040 of storing sight information,

In a case where a plurality of test images are output (S3010), various examples described above may apply to the method of display according to the present embodiment. Moreover, at least one image may be selected by the control unit's receiving the user's input signal (S3020). The eyesight may be selected based on the selected test image (S3030). At this point, Step of determining eyesight may include Step of selecting at least one image from among a plurality of test images with different focal distances, and determining the user's eyesight based on the maximum focal distance in a case where a plurality of images are selected.

For example, the control unit may output the plurality of images selected from among the test images, depending on the user's input. The user's eyesight may be determined based on the maximum focal distance for the plurality of selected images. The control unit may output the focus of the virtual image by varying it based on the user's eyesight determined based on the maximum focal distance.

With reference to FIG. 25, the electronic device may further include light reception element PD arranged on the frame 100. Accordingly, in determining the above-mentioned eyesight, test light TL (an image or the like) may be output to the user's eyeball through the optical device 200 and the display unit 300, and light (an image) reflected from the human's eyeball may be transferred to the light reception element PD. At this point, the control unit may determine the reflective index of the user's eyeball or the user's eyesight through light RL provided to the light reception element PD. Accordingly, as described above, the electronic device may output the virtual image by varying the focal distance based on the user's eyesight.

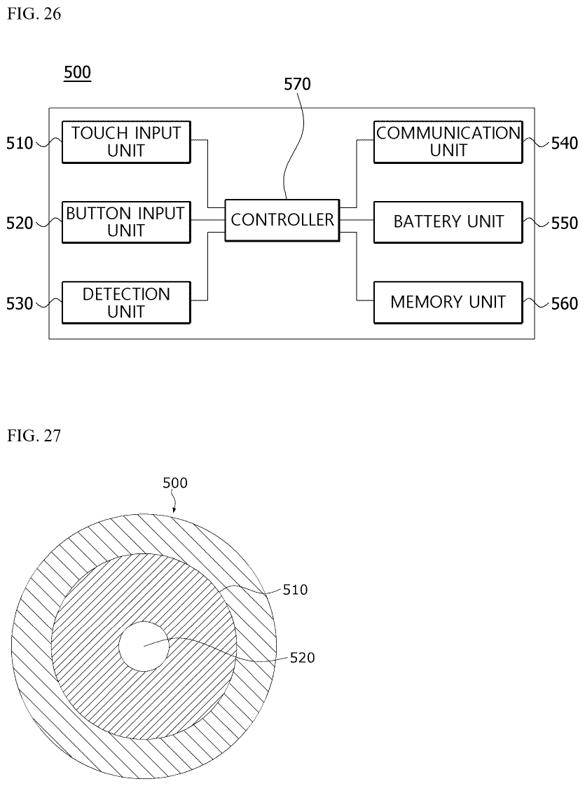

A method of control described with reference to FIGS. 26 to 34 may be executed by a controller or a control unit in the above-described control device or the electronic device. That is, except for the details described below, the controller may perform processing in each step of the method of control. The method of control according to the disclosed embodiment may be implemented in the form of program commands executable by various computer apparatuses and thus be recorded on a computer-readable medium. In addition, the embodiment of the present disclosure may be a computer-readable recording medium on which one or more programs containing commands executing the method of control.

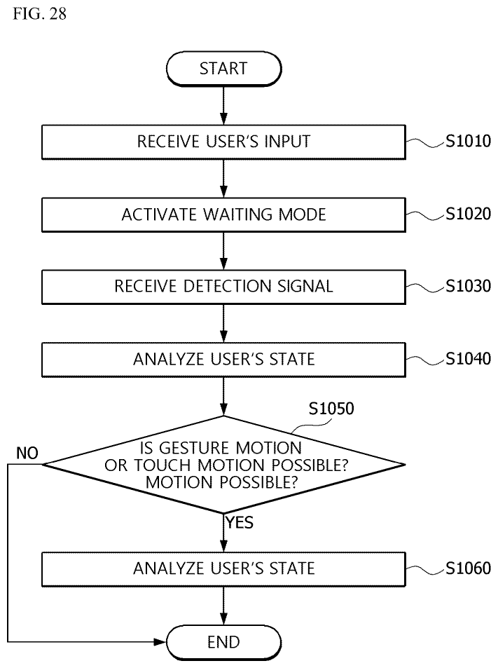

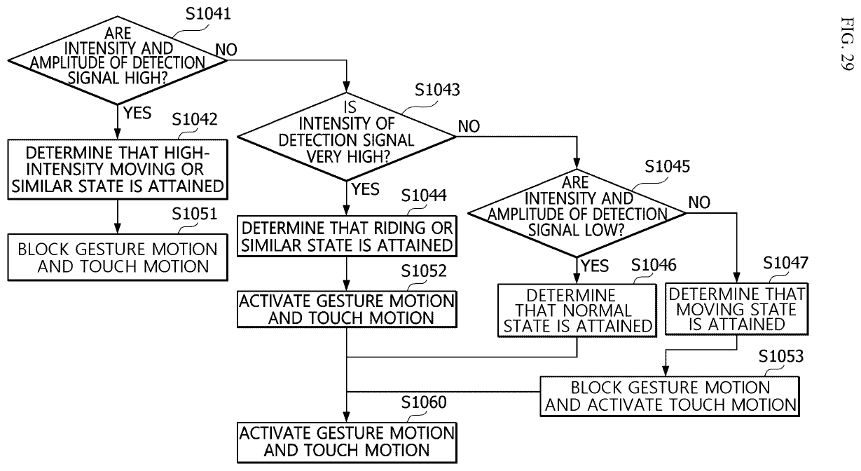

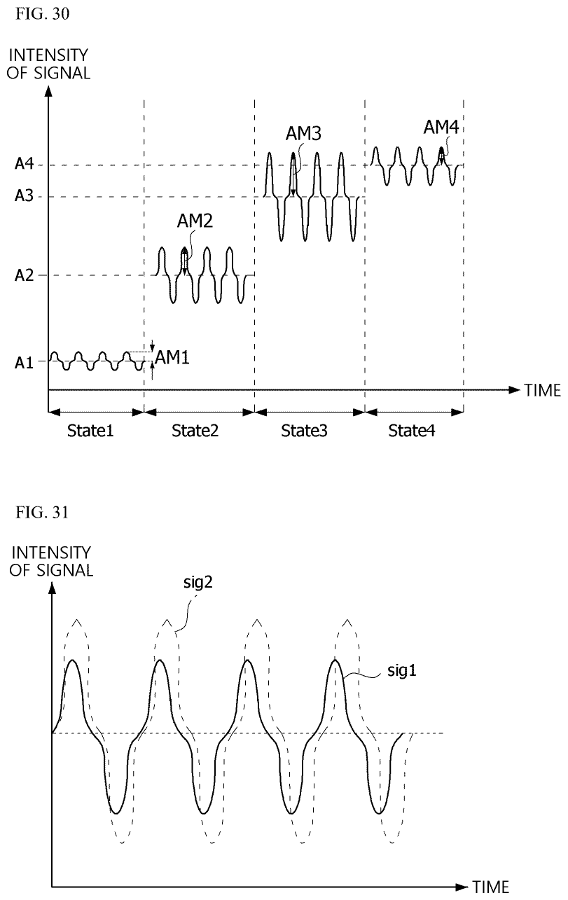

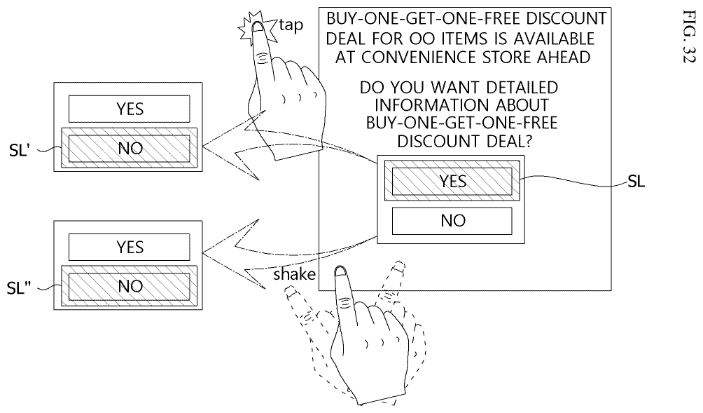

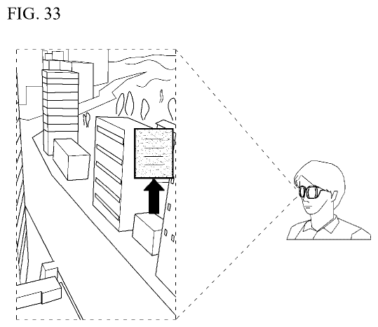

FIG. 26 is a block diagram illustrating a control device according to an embodiment of the present invention. FIG. 27 is a conceptual diagram illustrating the control device according to the embodiment of the present invention. FIG. 28 is a flowchart illustrating a method of control according to an embodiment of the present invention. FIG. 29 is a specific flowchart illustrating the method of control according to the embodiment of the present invention. FIG. 30 is a view that is referenced to describe operation of the control device according to the embodiment of the present invention and the method of control. FIG. 31 is a view that is referenced to describe operation and control between the control device according to the embodiment of the present invention and an electronic device. FIG. 32 is a view illustrating an interface of an electronic device according to an embodiment of the present invention. FIG. 33 is a view that is referenced to describe operation of the electronic device that uses the control device according to the embodiment of the present invention. FIG. 34 is a view that is referenced to describe the control device according to the embodiment of the present invention.

With reference to FIGS. 26 and 27, a control device 500 according to an embodiment may include a touch input unit or a first input unit 510, a button input unit or a second input unit 520, a detection unit 530, a communication unit 540, a battery unit or a power supply unit 550, a memory unit or a storage unit 560, and a controller 570.

The touch input 510 may detect the user's touch. For example, the touch input 510 may include a decompression sensor or the like. The touch input 510 may output a signal for the user's detected touch to the controller 570 or the like. In an embodiment, the touch input 510 may set the position of the control device 500 by detecting the user's touch, and detect various touch motions.

The upward, downward, leftward, and rightward directions of the control device 500 according to the embodiment may be configured by a technique described below. That is, the upward, downward, leftward, and rightward directions of the control device 500 may not be structurally configured. For example, the control device 500 may be configured in a circular or similar shape and thus have a structure symmetrical with respect to one imaginary line. The touch input 510 may be positioned outward from the button input unit 520 described below. For example, the touch input 510 may surround the button input unit 520 positioned at the center. The touch input 510 may also be configured as a touch screen. With this configuration, the control device according to the embodiment serves as a control device (for example, a remote controller) for an electronic device and may easily perform operation or control of the electronic device using a human sensory organ (for example, a tactile organ), That is, the user's sense of sight is not necessary to control the control device, and thus the electronic device may be easily controlled in various environments and spaces.

For example, the touch input 510 receives various inputs (for example, swiping input and tapping) and the like from the user and may output signals corresponding to these inputs.

The button input unit 520 may detect button inputs from the user or other individuals. For example, the button input unit 520 may be configured to have various structures and output signals, corresponding to the user's applied pressure, to the controller 570 or the like. In an embodiment, an image output by the electronic device through the button input unit 520, or information within the image may be selected.

The button input unit 520 may be positioned at the center of the control device 500. Accordingly, the user can easily find the button input unit 520. Moreover, the button input unit 520 may have an outwardly protruding shape or a grooved shape. Accordingly, the user can control the electronic device using their finger (for example, their thumb). For example, the button input unit 520 may be used to control whether or not either the electronic device or the control device is powered on. Alternatively, the button input unit 520 may be used to control whether or not an operation in conjunction with the electronic device is performed or whether or not an input waiting mode in the electronic device is activated.

The detection unit 530 may be configured with various motion sensors. The detection unit 530 may output a detection signal that includes motion information. For example, the detection unit 530 may include an IMU sensor. For example, the detection unit 530 may include a gyro sensor, an acceleration sensor, an angular sensor, an angular velocity sensor, and a geomagnetic field sensor. The motion information may include information about speed or acceleration. The detection unit 530 may be present within the control device or may also correspond to the sensing unit of the electronic device. Accordingly, the control unit of the control device may also receive a detection signal from the sensing unit of the electronic device.

As an embodiment, the detection unit 530 may also detect the gravitational direction of the control device 500 and the degree to which the control device 500 is inclined. In addition, posture information from the detection unit 530 may be used similarly to swiping information (which is input) through the touch input 510. Accordingly, regardless of the direction of the control device 500, the user can easily control the electronic device.

For example, when the control device 500 is inclined to the left or the right, a command corresponding to a direction key may be transferred to the electronic device.

The communication unit 540 may transmit and receive data to and from the electronic device. Alternatively, the communication unit 540 may include at least one module that enables wireless communication with an external server.

The battery unit 550 may supply electric power to the control device. Data that support various functions may be stored in the memory unit 560, which serves as a storage unit. Examples of the memory unit 560 may include a read-only memory (ROM), a random access memory (RAM), a flash memory, a memory card, and/or other storage devices.

The controller 570 may perform processing of the method of control, which is described below. The controller 570 may refer to a processor, a control unit, or similar the like. In addition, the controller 570 may include an application-specific integrated circuit (ASIC), a different chipset, a logic circuit, and/or a data processing device.

In an embodiment, the controller 570 is described as executing the method of control, which is described below.

Further with reference to FIGS. 28 and 29, the method of control according to the embodiment includes: Step S1010 of receiving a user's input; Step S1020 of activating a waiting mode; Step S1030 of receiving a detection signal; Step S1040 of determining the user's state; Step S1050 of determining activation of a gesture motion or a touch motion in a manner that corresponds to the user's determined state; and Step S1060 of transmitting a command corresponding to the activated motion.

The controller 570 may receive the user's input through the button input unit or the touch input unit (S1010). Accordingly, the controller 570 may wake up the control device, that is, the controller 570 may activate the waiting mode of the control device (S1020).

Subsequently, the controller 570 may receive a detection signal from the detection unit 530 (S1030). At this point, the controller 570 may determine the user's state using the detection signal received from the detection unit 530 (S1040). Examples of the user's state may include a stationary state, a moving state, an exercise state, and a riding state. These states are exemplary and may also be expressed as a plurality of states (for example, States 1 to 4).

Subsequently, the controller 570 may determine the activation of the gesture motion or the touch motion in a manner that corresponds to the user's determined state (S1050). The controller 570 may transmit a command to the electronic device in a manner that corresponds to the activated motion (S1060). For example, the controller 570 may activate only the gesture motion. In this case, although the user performs the touch motion, an output or command that corresponds to the touch motion may not be transmitted to the electronic device. In addition, the controller 570 may activate only the touch motion. In this case, although the user performs the gesture motion, an output or command that corresponds to the gesture motion may not be transmitted to the electronic device.

More specifically, in the method of control according to the embodiment, Step S1040 of determining a user's state includes Step S1041 of comparing whether or not the amplitude of a detection signal is above a second setting value, in a case where the intensity of the detection signal is above a first setting value.

First, with reference to FIG. 30, in the stationary state (State 1), the intensity A1 (for example, average intensity) and amplitude AM1 of the detection signal may be lowest compared to those in the other states.

In the moving state (State 2), the intensity of the detection signal may be higher than in State 1, and the amplitude AM2 may be lower than in States 1 and 4. Moreover, in the moving state, the intensity of the detection signal may be lower than in States 3 and 4. In the moving state, the amplitude AM2 of the detection signal may be lower than in State 3.

In the exercise state (State 3), the intensity A3 of the detection signal may be higher than in States 1 and 2 and be lower than in State 4. In the exercise state, the amplitude AM3 of the detection signal may be highest compared to those in the other states.

Moreover, in the riding state (State 4), the intensity A4 of the detection signal may be highest compared to those in the other states. In the riding state, the amplitude AM4 of the detection signal may be higher than in State 1 and be lower than in States 2 and 3.

Accordingly, in a case where the intensity of the detection signal is above the first setting value, it may be compared whether or not the amplitude of the detection signal is above the second setting value. At this point, the first setting value may range between a value of A3 and a value of A2.

The method of control according to the embodiment may include Step S1042 of determining the user's state as the exercise state when the amplitude of the detection signal is above the second setting value.

That is, when the amplitude of the detection signal is above the second value, the controller may determine the user's state as the exercise state (S1042). The second setting value may range between a value of AM3 and a value of AM4.

The method of control may include Step S1043 of comparing whether or not the intensity of the detection signal is above a third setting value when the amplitude of the detection signal is below the second setting value.

For example, when the amplitude of the detection signal is below the second setting value, the controller may compare whether or not the intensity of the detection signal is above the third setting value (S1043).

Subsequently, the method of control may include Step S1404 of determining the user's state as the riding state when the intensity of the detection signal is above the third setting value.

That is, the controller may determine the user's state as the riding state when the intensity of the detection signal is above the third setting value (S1044). At this point, the third setting value may be higher than a value of A3. The third setting value may be higher than the first setting value.

The method of control may include Step S1045 of comparing whether or not the amplitude of the detection signal is above a fourth setting value when the intensity of the detection signal is below the first setting value. The fourth setting value may range between a value of AM1 and a value of AM2. The fourth setting value may be lower than the second setting value.

Subsequently, the method of control may include Step S1047 of determining the user's state as the moving state when the amplitude of the detection signal is above the fourth setting value.

When the amplitude of the detection signal is above the fourth value, the controller may determine the user's state as the moving state (S1047). That is, based on the amplitude, the controller may determine the user's state as a non-stationary state.

In addition, the method of control may include Step S1046 of determining the user's state as the stationary state when the amplitude of the detection signal is below the fourth setting value.

The controller may determine the user's state as the stationary state in which the user hardly moves, when the amplitude of the detection signal is below the fourth setting value (S1046).

After determining the user's state as described, the controller may accordingly determine activation of the gesture motion and the touch motion.

When the amplitude of the detection signal is above the second value, the controller may determine the user's state as the exercise state (S1042). Subsequently, the controller may block both the gesture motion and the touch motion (S1051).

The controller may determine the user's state as the riding state when the intensity of the detection signal is above the third setting value (S1044). Subsequently, the controller may activate the gesture motion and the touch motion (S1052).

The controller may determine the user's state as the stationary state in which the user hardly moves, when the amplitude of the detection signal is below the fourth setting value (S1046). Subsequently, the controller may activate the gesture motion and the touch motion (S1052).

When the amplitude of the detection signal is above the fourth value, the controller may determine the user's state as the moving state (S1047). Subsequently, the controller may stop the gesture motion and activate the touch motion.

Accordingly, cases (erroneous input cases) where a touch or gesture is unintentionally input by the user can be easily inhibited. In other words, even when the user is stationary without moving, the method of control according to the embodiment may accurately transmit a control command to the electronic device according to the user's input without any erroneous input.

Further with reference to FIG. 31, the electronic device, as described above, may include the sensing unit. Accordingly, the electronic device or the control device may transmit and receive the detection signals to and from each other. For example, in a case where the difference between a detection signal sig1 from the sensing unit of the electronic device and a detection signal sig2 from the detection unit of the control device falls within a predetermined range, a command from the control device may be provided to the electronic device.

Further with reference to FIG. 32, the user can recognize various objects on a real image through the electronic device. Moreover, the electronic device may provide a virtual object or the like in a manner that corresponds to an object in a real image. For example, the electronic device may output information corresponding to a real image (for example, a building), as a virtual object, to the user.

Further with reference to FIG. 33, the user can output a command to move or select a virtual object, using the control device according to the embodiment. That is, the user may select an object (for example, a virtual object or information (a memo picture)) through the control device based on the user interface illustrated in FIG. 32. For example, when an object in the form of a memo illustrated in FIG. 32 is selected, the screen may switch to FIG. 33.

Subsequently, for example, in a case where the user is stationary, as described above, the controller may activate the gesture motion and the touch motion. Accordingly, in a case where the user taps the control device, the control device may move a selection target or a selection object from “YES” to “NO” (SL′) or transmit a command to select a specific object to the electronic device.

In addition, in a case where the user shakes the control device in a specific manner (for example, a certain number of times), the control device may move the selection target or the selection object from “YES” to “NO” (SL′) or transmit the command to select a specific object to the electronic device.

Moreover, further with reference to FIG. 34, when the touch motion is activated, the controller may configure the user's initial input position as one of the following: upward, downward, leftward, or rightward with respect to the center portion.

For example, the touch motion may be activated in any one of the user's states described above. At this point, the controller may make a selection as one of the following: upward, downward, leftward, or rightward with respect to a region AR1 (an initial input) that is initially input by the user to a touch input unit. At this point, the controller may configure a first imaginary line VL1, connecting the button input unit 520, which is the center portion, and the initial input, and a second imaginary line VL2, perpendicular to the first imaginary line VL1, dividing the touch input unit 510 into two halves. The controller may configure a direction as one of the following: upward, downward, leftward, or rightward with respect to the first imaginary line VL1 and the second imaginary line VL2.

For example, in a case where the user touches particularly the ‘left’ side of the second imaginary line VL2 after the initial input, the control device may transmit a command to move to the ‘left’ to the electronic device. The electronic device may execute the command in a manner that corresponds to the user's touch (input).

In this manner, while on the move, the user can provide input to or execute a command for the electronic device through the control device. At this point, even if the user's entire body is shaken, the control device may easily inhibit erroneous input. Moreover, the user can also experience convenience while on the move.

The method of control according to the disclosed embodiment may be implemented in the form of program commands executable by various computer apparatuses and thus be recorded on a computer-readable medium. In addition, the embodiment of the present disclosure may be a computer-readable recording medium on which one or more programs containing commands to execute the method of control.

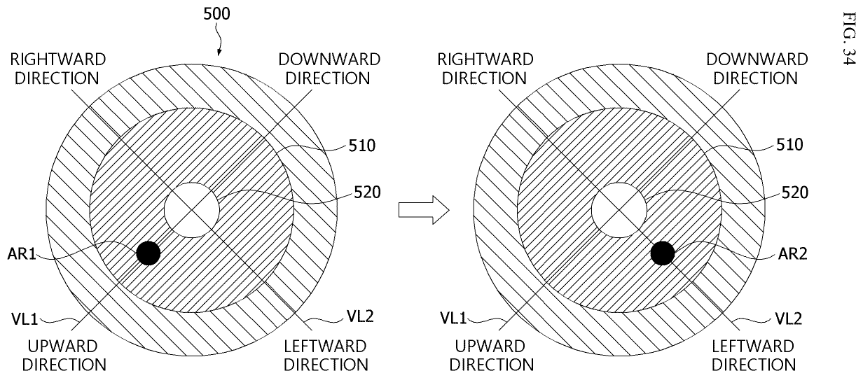

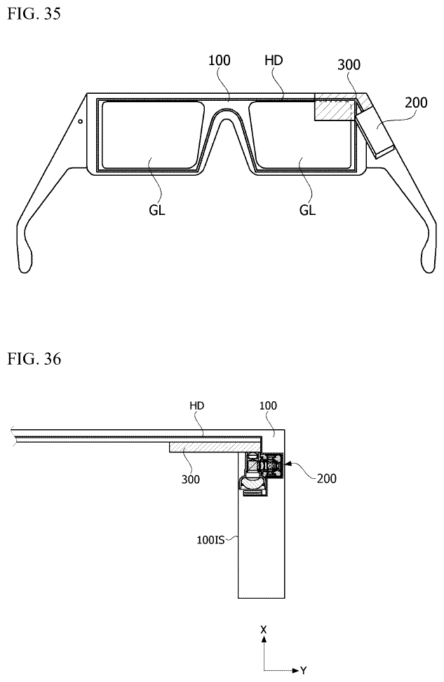

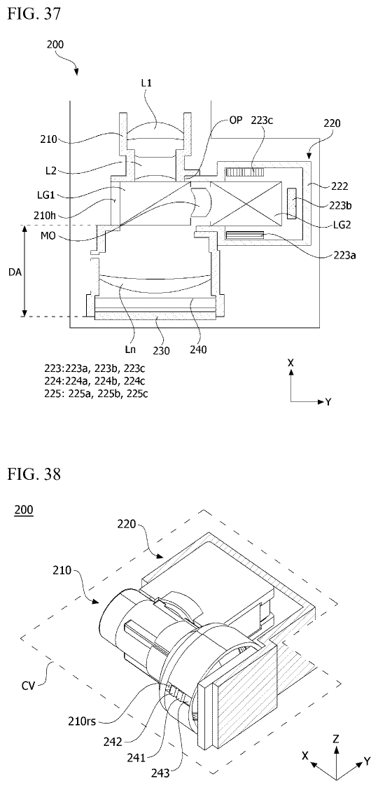

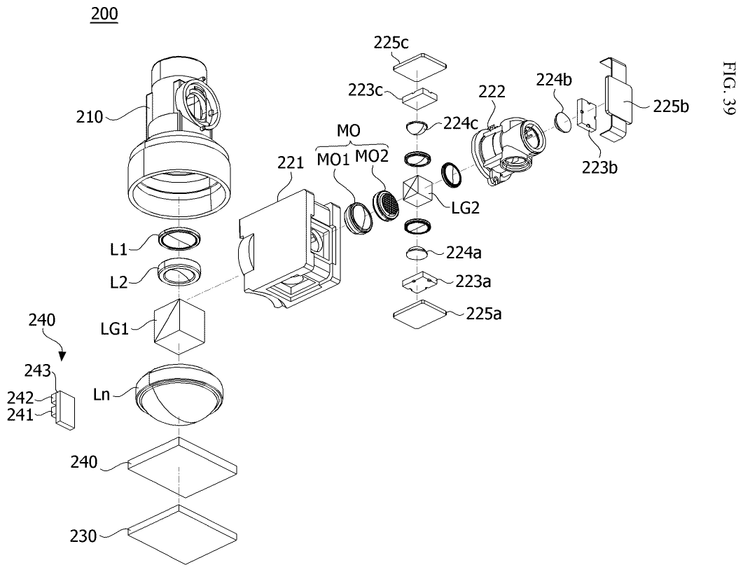

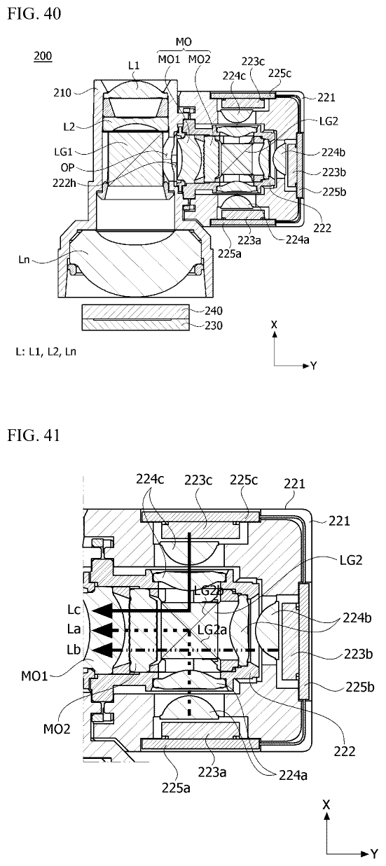

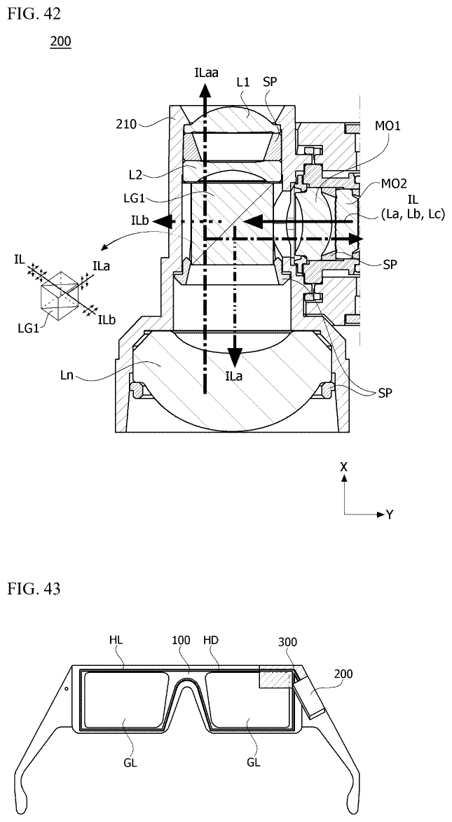

FIG. 35 is a side view illustrating an electronic device according to an embodiment. FIG. 36 is a plan view illustrating the electronic device according to the embodiment. FIG. 37 is a conceptual diagram illustrating an optical device according to an embodiment. FIG. 38 is a perspective view illustrating the optical device according to the embodiment. FIG. 39 is an exploded perspective view illustrating the optical device according to the embodiment. FIG. 40 is a view taken along line AN on FIG. 38. FIG. 41 is an enlarged view illustrating Portion K1 of FIG. 40. FIG. 42 is an enlarged view illustrating Portion K2 of FIG. 40.

With reference to FIGS. 35 and 37, the electronic device according to the embodiment, as described above, may include the frame 100, the optical device 200, the display unit 300, and a heat dissipation unit HD.

The frame 100, as described, may be an eyeglass frame.

The optical device 200 may be arranged on the frame 100 and generate an image. Accordingly, the optical device 200 may include the light source.

The display unit 300 may be connected to the optical device 200 and output the image generated by the optical device 200. To this end, the optical device 200 may include the optical signal generation unit 230.

The heat dissipation unit HD may be connected to the optical device 200. The heat dissipation unit HD may be arranged within the frame 100. With this configuration, a fogging or similar phenomenon caused by environmental conditions can be easily inhibited by the heat dissipation unit HD.

The heat dissipation unit HD may come into contact with the light source of the optical device. Accordingly, heat generated by the light source of the optical device can be easily dissipated. Accordingly, when the user wears the frame, the user's skin can be inhibited from being damaged by the optical device. Moreover, the reliability of the optical device can be improved.

The heat dissipation unit HD may come into contact with a substrate of the light source device in the optical device 200. More specifically, the heat dissipation unit HD may come into contact with the substrate that is in contact with the light source. To this end, the substrate may be exposed out of the housing of the light source device. That is, through the exposed surface, the heat dissipation unit HD may easily come into contact with the substrate on which the light source is mounted, and the heat dissipation unit may easily perform dissipation.

Further with reference to FIGS. 37 to 40, an optical device 200 according to an embodiment include a barrel 210, a lens L, and a first light guide LG1. Moreover, the optical device 200 may include a light source device 220 that is positioned in or coupled to an opening portion OP formed in a lateral surface of the barrel 210, and an optical signal generation unit 230 adjacent to the barrel 210. Moreover, the optical device 200 may further include a cover CV, which covers the barrel 210, the light source device 220, and the optical signal generation unit 230, and a substrate (not illustrated) that includes a connector.

The lens L may include a plurality of lenses. For example, the lens L may include a plurality of lenses arranged sequentially from the top of the barrel 210. For example, the lens L may include a first lens L1, which is arranged at the uppermost position, a second lens L2, which is arranged underneath the first lens L1, and so forth up to an N-th lens Ln, which is arranged at the lowermost position. At this point, N may be a natural number that is greater than or equal to 2. Among the plurality of lenses L, the N-th lens Ln may be positioned closest to the optical signal generation unit 230, which is positioned under the lower end of the barrel 210 or under the lowermost lens of the plurality of lenses L.

In addition, in an embodiment of the present invention, a first direction (the X-axis direction) may correspond to the optical axis. In addition, the first direction (the X-axis direction) may correspond to a direction in which light that is emitted from the light source device 220 and reflected from the optical signal generation unit 230 is emitted to the above-described display unit. A second direction (the Y-axis direction) is a direction perpendicular to the first direction (the Y-axis direction). Moreover, the second direction (the Y-axis direction) may correspond to the direction from the first light guide LG1 toward an opening portion OP. In addition, hereinafter in the present specification, or in the present embodiment, the second direction (the Y-axis direction) may correspond to the direction from the first light guide LG1 toward a second light guide LG2. The first light guide LG1 may be referred to as a first light guide unit or a first guide member. In addition, the second light guide LG2 may be referred to as a second light guide unit or a second guide member.

The barrel 210 may further have a hole corresponding to the opening portion OP. As an embodiment, the barrel 210 may have a barrel hole or an additional hole 210h. The additional hole 210h may be positioned in a manner that faces the opening portion OP. Alternatively, the additional hole 210h may overlap with the opening portion OP in the second direction (the Y-axis direction). Alternatively, the distance in the first direction from the N-th lens Ln to the additional hole 210h may be the same as the distance between the opening portion OP and the N-th lens Ln. Alternatively, the additional hole 210h may be positioned in a region, corresponding to the position of the opening portion OP, of the internal surface of the barrel 210. With this configuration, a joining member may be easily applied to the light source device 220 that is coupled to, inserted into, fixed to, or connected to, the opening portion OP through the additional hole 210h. Accordingly, the binding force between the barrel 210 and the light source device 220 may be enhanced. Therefore, the optical device 200 according to the embodiment may have durability, endurance, or reliability that is enhanced. Alternatively, optical tests may also be easily performed on the light source device 220, positioned in the opening portion OP, through the additional hole 210h. Alternatively, fluid (for example, air) discharge or dispensing through the additional hole 210h may be easily performed on the barrel 210 and the light source device 200 through the additional hole 210h. The presence or absence of the additional hole 210h may apply in a manner that varies from one embodiment to another. For example, the additional hole 210h, as described above, may be arranged on the lateral surface of the barrel 210. Alternatively, the additional hole 210h may not be present on the lateral surface of the barrel 210, considering durability or similar factors.

A plurality of lenses L may be positioned within the barrel 210. In addition, the first light guide LG1 may be positioned within the barrel 210.

The barrel 210 according to the embodiment may include the opening portion OP formed in the lateral surface thereof. The opening portion OP may have various shapes, such as a circle and a polygon. The opening portion OP may correspond to the position of the first light guide LG1.

As an embodiment, the opening portion OP may overlap with the first light guide LG1 in the direction perpendicular to the optical axis. With this configuration, light emitted from the light source device 220 positioned on a lateral portion of the barrel 210 may be easily incident on the first light guide LG1.

The first light guide LG1 may be arranged between two lenses of a plurality of lenses. For example, the first light guide LG1 may be arranged between the first lens L1 and the N-th lens Ln. In addition, the first light guide LG1 may be arranged between the first lens L1 and the optical signal generation unit 230. In addition, the first light guide LG1 may be arranged between the first lens L1 and the second lens L2 or between the second lens L2 and the N-th lens Ln. In various embodiments, these various positions of the first light guide LG1 are described below.

In the present embodiment, the first light guide LG1 may be positioned between the second lens L2 and the N-th lens Ln. Accordingly, the N-th lens Ln may be arranged between the first light guide LG1 and the optical signal generation unit 230. With this configuration, light reflected from the first light guide LG1 may be provided to the optical signal generation unit 230, thereby securing a suitable light path. In addition, refraction of the reflected light may be achieved. Accordingly, minimization of the first light guide LG1 may be achieved.

The first light guide LG1 may include a first prism. The first prism may be a polarizing prism. In addition, the first prism may be a polarized separation prism.

The first prism may reflect first polarized light and transmit a second polarized light. For example, a portion (the first polarized light) of light provided from the light source device 220 or incident on the first light guide LG1 may be reflected from the first light guide LG1 and be provided to the optical signal generation unit 230. Another portion (the second polarized light) of the light incident on the first light guide LG1 may pass through the first light guide LG1 and be absorbed into the barrel 210.

The light emitted from the light source device 220 through the opening portion OP may be incident on the first light guide LG1. To this end, as described above, the opening portion OP may be arranged in a region where the first light guide LG1 is positioned. For example, the incident surface of the first light guide LG1 may be positioned in a manner that faces the opening portion OP. Alternatively, the position of the first light guide LG1 in the barrel 210 may be the same as that of the first light guide LG1.

The light source device 220 may include a light source 223 and thus generate (produce or provide) light. The light source device 220 according to the embodiment may be positioned in or coupled to the opening portion OP. That is, the light source device 220 may be connected or coupled to the barrel 210.

The light source device 220 may include a housing 222 having an opening 222h, the second light guide LG2 arranged within the housing 2220, and the light source 223 that provides light to the second light guide LG2.

Moreover, the light source device 220 may include a light source assembly 221 that is arranged on the outer side of the light source device 220 and covers the housing 222, a light source lens 224 adjacent to the light source 223, and a medium lens MO positioned within the housing 222.

The light source assembly 221 may be arranged at the outermost edge of the light source device 220. In a case where the light source 223 is difficult to mount within the housing 222 or where it is necessary to mount an additional lens (a light source lens), the light source assembly 221 may be positioned outside the housing 222. The light source assembly 221 may have a structure that is integrally formed with the housing 222 or separated from the housing 222.

The housing 222 may have the opening 222h. The housing 222 may be positioned adjacent to the opening portion OP in the barrel 210. For example, the opening 222h in the housing 222 may be positioned in a manner that corresponds to the opening portion OP in the barrel 210. Accordingly, the opening 222h in the housing 222 may overlap with the opening portion OP in the barrel 210 in the second direction (the Y-axis direction).

The light source 223 may be positioned within the housing 222 or the light source assembly 221. The light source 223 may emit light. For example, light from the light source 223 may be incident on the second light guide LG2 within the housing 222. The second light guide LG2 may be positioned within the housing 222. Accordingly, the second light guide LG2 may transfer light emitted from the light source 223 to either the opening 222h or the first light guide LG1.

The light source 223 may include one or more light sources. That is, in the light source device 220, the light source 223 may refer to a single light source and include a plurality of light sources. The light source 223 may include a plurality of light sources, for example, a first light source 223a, a second light source 223b, and a third light source 223c. The first to third light sources 223a to 223c may emit light in the same direction or in different directions. For example, the first light source 223a and the third light source 223c may be positioned in a manner that faces each other. The first light source 223a and the third light source 223c may be positioned to overlap with each other in the first direction (the X-axis direction). The second light guide LG2 may be positioned between the first light source 223a and the third light source 223c. Accordingly, the second light guide LG2 may overlap with the first light source 223a and the third light source 223c. The second light source 223b may be positioned between the first light source 223a and the third light source 223c. The first to third light sources 223a to 223c may emit light toward the second light guide LG2. The second light source 223b may overlap with the second light guide LG2 in the second direction. With this configuration, the optical device 200 may have the compact light source device 220.

In addition, the first light source 223a, the second light source 223b, and the third light source 223c may emit light at the same wavelength or color, or emit light at different wavelengths or in different colors. For example, the first light source 223a, the second light source 223b, and the third light source 223c may emit red, green, and blue light, respectively.

The second light guide LG2 may include a second prism. The second prism serves as a reflection member and may include, for example, an X-prism. As an embodiment, the second light guide LG2 or the second prism may have a structure in which at least two prisms are coupled to each other.

The second prism may have at least two coated surfaces (reflection members or reflection sheets). One of the at least two coated surfaces may reflect light at a first wavelength and light at a second wavelength and transmit light at a third wavelength. That is, the coated surface may reflect light in a predetermined wavelength band. Accordingly, the light in a desired wavelength band, which is emitted from each of the plurality of light sources 223, may be reflected from the second light guide LG2. For example, the light passing through the second light guide LG2 may be provided to the first light guide LG1 or the medium lens MO.

The light source lens 224 may be positioned adjacent to the light source 223. For example, the light source lens 224 may include a plurality of light source lenses. The light source lens 224 may be positioned on a path of light emitted from each light source 223.

As an embodiment, the light source lens 224 may be positioned between the second light guide LG2 and the light source 223. In addition, the light source lenses 224 may include a plurality of light source lenses. The plurality of light source lenses 224 may be positioned between the second light guide LG2 and the light source 223. Alternatively, the plurality of light source lenses 224 may be provided in such a manner as to correspond to the plurality of light sources 223, respectively.

For example, the light source lens 224 may include a first light source lens 224a, a second light source lens 224b, and a third light source lens 224c. The first light source lens 224a may be positioned between the first light source 223a and the second light guide LG2. The second light source lens 224b may be positioned between the second light source 223b and the second light guide LG2. The third light source lens 224c may be positioned between the third light source 223c and the second light guide LG2.

In addition, the plurality of light source lenses, for example, the first light source lenses 224a, the second light source lenses 224b, and the third light source lenses 224c may be positioned on the plurality of light sources, for example, the first light source 223a, the second light source 223b, and the third light source 223c, respectively. For example, any one of the plurality of first light source lenses 224a may be positioned on the first light source 223a and coupled to the light source assembly 221. Another one of the plurality of first light source lenses 224a may be positioned between the previously mentioned first light source lens 224a and the second light guide LG2 and coupled to the housing 222.

The first light source lens 224a, the second light source lens 224b, and the third light source lens 224c may include a collimation lens or a collimator.

In addition, a substrate 225 connected to the light source 223 may be arranged in the light source assembly 221. The substrate 225 may refer to a single substrate or include a plurality of substrates in a manner that corresponds to the light source 223. For example, a plurality of substrates 225 may include a first substrate 225a, a second substrate 225b, and a third substrate 225c. As described above, the plurality of substrates 225 may either form a single integrated substrate or correspond to the number of the light sources.

In addition, the substrate 225 may be electrically connected to a control unit or a processor within the above-described frame (or display unit). Accordingly, the substrate 225 may include a connector for communicating with either an external apparatus or a connected apparatus. Moreover, the substrate 225 may be arranged outside the light source 223 and dissipate heat generated in the light source to the outside. Accordingly, the reliability of the light source device 220 can be enhanced.

The medium lens MO may be positioned between the opening 222h and the second light guide LG2. In addition, the medium lens MO may be positioned between the first light guide LG1 and the second light guide LG2.

The medium lens MO may include a plurality of lenses. For example, the medium lens MO may include a first medium lens MO1 and a second medium lens MO2. However, as described below, without the medium lens MO, the light reflected from the second light guide LG2 may also be provided directly to the first light guide LG1.

The first medium lens MO1 may have a first surface MO1s1 adjacent to the first light guide LG1 and a second surface MO1s2 corresponding to the first surface MO1s1. The light emitted from the light source 223 may pass through the second light guide LG2 and then sequentially pass through the first surface MO1s1 and the second surface MO1s2.

The second surface MO1s2 may be convex toward the second light guide LG2. Alternatively, the second surface MO1s2 may be concave toward the first light guide LG1. Moreover, the first surface MO1s1 may be either convex or concave toward the second light guide LG2. For example, the first medium lens MO1 may have the shape of a meniscus. Since the second surface MO1s2 is convex toward the second light guide LG2 in this manner, light may converge while passing through the medium lens MO. Accordingly, the regularity or uniformity of the light provided to the optical signal generation unit 230 can be improved. In other words, the light incident on the optical signal generation unit 230 may be surface light. Then, the uniformity of the surface light can be improved. Accordingly, the accuracy or resolution of either an image signal or an image emitted to the display unit through the optical device 200 according to the embodiment can be improved.

The second medium lens MO2 may include a microlens array (MLA). Accordingly, surface-illumination may be partially performed on the light passing through the second light guide LG2.

Moreover, the second medium lens MO2 may have a different size than the second light guide LG2. In addition, the first medium lens MO1 may have a different size than the second light guide LG2. For example, the medium lens MO2 may have a greater size than the second light guide LG2.

Moreover, the positions of the plurality of lenses L, the positions of the plurality of medium lenses MO, and the positions of the plurality of light source lenses 224 may be maintained by spacers SP. For example, a plurality of spaces SP adjacent to the plurality of lenses L, respectively, may be present within the barrel 210. In addition, a plurality of spaces SP may be arranged in either the housing 222 or the light source assembly 221 of the light source device 220 in a manner that is adjacent to each of the medium lens MO and the light source lens 224. As an embodiment, the plurality of spaces SP may be arranged over or under the above-described lens and thus fix or maintain the position of the lens.

The optical signal generation unit 230 may be positioned under the lower end of the barrel 210. The optical signal generation unit 230 may overlap with the lens L either in the optical axis or in the first direction (the X-axis direction).

The optical signal generation unit 230 may convert light, which is incident on the first light guide LG1, reflected, and then passes through the N-th lens, into an optical signal including image information.

The optical signal generation unit 230 may reflect the light (the first polarized light) reflected from the first light guide LG1. The optical signal generation unit 230 may generate an optical signal including image information. That is, the light emitted from the optical signal generation unit 230 may be light including image information.

The optical signal generation unit 230 may include a liquid crystal on silicon (LCoS) device.

The liquid crystal on silicon device may have a structure in which liquid crystal is dispensed between a silicon wafer (a thin circular substrate material for semiconductors) with a Complementary Metal-Oxide Semiconductor (CMOS) array, and an Anti-Reflection (AR) member coated with a transparent electrode (Indium Tin Oxide (ITO)).

An alignment layer may be formed on top of a wafer (a silicon wafer) and thus form an initial liquid crystal orientation.

Moreover, either a reflection layer or a reflection electrode that is formed as an aluminum layer and has a high optical reflectance may be positioned underneath the alignment layer. The reflection electrode may be positioned on top of the silicon wafer. A semiconductor array (CMOS array) may be formed on top of the silicon wafer. Transmission of a data signal to this semiconductor array through the panel may be achieved.

The optical signal generation unit 230 may reflect at least one portion of the incident light, depending on the driving of the optical signal generation unit 230. The optical signal generation unit 230 may reflect light incident from a surface light source on a per-pixel basis. In addition, the intensity of the reflected light may also be adjusted depending on the degree of modulation. For example, the optical signal generation unit 230 may modulate one portion of the first polarized light into the second polarized light. Accordingly, the second polarized light, resulting from modulation, may pass through the first light guide LG1 and the first lens L1 and then be provided to the display unit.

That is, the optical signal generation unit 230 may modulate retardation of the light, resulting from the modulation, that is, the polarized light. The optical signal generation unit 230 may perform retardation of the first polarized light in various ways. That is, an electric field may be formed by adjusting voltage for each pixel (voltage of an electrode). The degree to which liquid crystal is twisted may also be adjusted depending on the adjusted voltage. For example, when a maximum voltage is applied, the light reflected from the optical signal generation unit 230 may be all reflected from the first light guide LG1. When a minimum voltage is applied, the light reflected from the optical signal generation unit 230 may all pass through the second light guide LG1. However, the light reflected from the optical signal generation unit 230 may also conversely propagate depending on the electric field. In addition, when a middle-level voltage is applied, one portion of the light may pass through the first light guide LG1. That is, the intensity (for example, the brightness) of the light provided to the display unit may be approximately at a middle level.

In this manner, an optical signal generated by the optical signal generation unit 230 may be transferred to the first lens L1 through the N-th lens Ln and the first light guide LG1. Moreover, at least one portion of the optical signal generated by the optical signal generation unit 230 may pass through the first lens L1 and be incident on the display unit.

Additionally, a transparent member 240 may be further arranged between the optical signal generation unit 230 and the N-th lens Ln (or the first light guide). The transparent member 240 may be a glass pane. The transparent member 240 may be coupled to the barrel 210 or the cover CV. Moreover, the transparent member 240 may be positioned over the optical signal generation unit 230. Accordingly, foreign material can be easily blocked from being introduced into the optical signal generation unit 230. The transparent member 240 may have the same size as or a different size than the optical signal generation unit 230. Moreover, the transparent member 240 may overlap with at least one portion of the optical signal generation unit 230 either in the optical axis or in the first direction (the X-axis direction).

Moreover, a heat dissipation unit HD may extend from the external surface of the housing 222 toward a frame 100. As described, the heat dissipation unit HD may be arranged on the external surface of the housing 222 in such a manner as to come into contact with the substrate 225 exposed out of the housing 222. At this point, the heat dissipation unit HD may not be positioned on the internal surface 200IS of the optical device 200. That is, the heat dissipation unit HD may be positioned on the surface opposite the internal surface 200IS of the optical device 200. Moreover, the heat dissipation unit HD may be positioned on the surface opposite the internal surface 100IS of the frame 100. That is, the heat dissipation unit HD may not be arranged along the internal surface 100IS of the frame 100.

The heat dissipation unit HD may extend along the external surface of the housing 222, thereby progressing toward the frame on the front side. In addition, the heat dissipation unit HD may extend along the edge of glass lenses or lenses GL inward from the frame.

Moreover, the heat dissipation unit HD may extend adjacent to the optical signal generation unit 230. For example, the heat dissipation unit HD may extend from the light source device 220 to below the optical signal generation unit 230. Accordingly, heat generated by the optical signal generation unit 230, as well as by the light source may be easily dissipated to the outside. At this point, the heat dissipation unit HD, as described above, may extend along the surface opposite the internal surface of the optical device 200IS, that is, the external surface of the optical device. Accordingly, this configuration ensures that the wearer does not feel the heat. That is, the heat dissipation unit HD may extend upward from below the optical signal generation unit 230 along the external surface of the optical device 200, that is, along the lateral surface of the optical device.

Further with reference to FIG. 41, light La, Lb, and Lc emitted from the light sources 223, respectively, may pass through the light source lens 224, the second light guide LG2, and the medium lens MO. For example, first light La, second light Lb, and third light Lc, which are emitted from first to third light sources 223a to 223b, respectively, may be emitted from the second light guide LG2 in the same direction.

For example, the second light guide LG2 may have a first coated surface LG2a and a second coated surface LG2b. As described above, one of at least these two coated surfaces may reflect one or more of the following: light at a first wavelength, light at a second wavelength, or light at a third wavelength. For example, the first wavelength includes in a wavelength band of red light. The second wavelength includes in a wavelength band of green light. The third wavelength includes in a wavelength band of blue light.

In addition, the first coated surface LG2a may reflect the first light La or light at the first wavelength. That is, the first coated surface LG2a may transmit second the light Lb and the third light Lc. In other words, the first coated surface LG2a may transmit light at the second wavelength and light at the third wavelength.

The second coated surface LG2b may reflect the second light Lb or the light at the second wavelength. That is, the second coated surface LG2b may transmit the first light La and the third light Lc. In other words, the second coated surface LG2b may transmit the light at the first wavelength and the light at the third wavelength.

Accordingly, the first light La may be reflected from the second light guide LG2 in a manner that propagates toward, or incident on, the medium lens MO or the opening portion OP. The second light Lb may be reflected from the second light guide LG2 in a manner that propagates toward, or incident on, the medium lens MO or the opening portion OP. In addition, the third light Lc may be reflected from the second light guide LG2 in a manner that propagates toward, or incident on, the medium lens MO or the opening portion OP.

Accordingly, light IL (or indicated by a combination of La, Lb, and Lc) emitted from the light source 223 may be incident on the first light guide LG. At this point, light that is incident on the first light guide LG may be first incident light IL.

Further with reference to FIG. 42, some of the first incident light IL may be reflected from the first light guide LG1, and the rest may pass through the first light guide LG1. That is, the first light guide LG1 may reflect first polarized light Ila of the first incident light IL and transmit second polarized light ILb thereof. For example, the first polarized light ILa and the second polarized light ILb may each be either S-polarized or P-polarized light. Accordingly, the first polarized light ILa that is one portion of the first incident light IL may be provided to the optical signal generation unit 230 through the N-th lens Ln. The second polarized light ILb may be absorbed into the barrel 210 or be provided to the additional hole 210h.

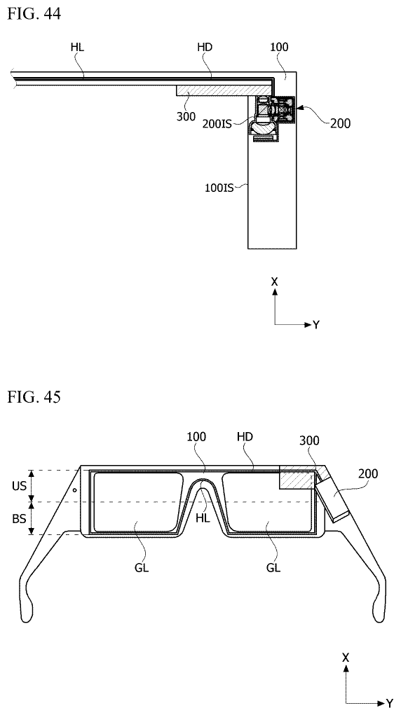

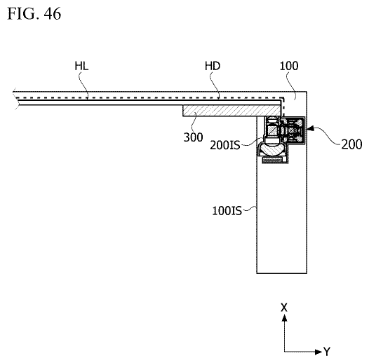

FIG. 43 is a side view illustrating an electronic device according to another embodiment. FIG. 44 is a plan view illustrating the electronic device according to the same embodiment. FIG. 45 is a side view illustrating an electronic device according to still another embodiment. FIG. 46 is a plan view illustrating the electronic device according to the same embodiment. Except for the details described below, the respective above descriptions of the frame, the optical device, the display unit, and the dissipation unit may apply in the same manner.

With reference to FIGS. 43 and 44, the electronic device according to the embodiment may further include a heat supply unit HL arranged on the fame 100.

The heat supply unit HL may be positioned within the frame 100. That is, like the heat dissipation unit HD, the heat supply unit HL within the frame 100 may surround the edge of the lens GL. Accordingly, the fogging or similar phenomenon can be more effectively inhibited.

The heat supply unit HL may also be electrically connected to the optical device 200. Moreover, the heat supply unit HL may be electrically connected to a controller or a control unit within the electronic device. Alternatively, the heat supply unit HL may be electrically connected to a controller or a control unit within the optical device.

The heat dissipation unit HD and the heat supply unit HL may be sealed with a sealing member (for example, epoxy) in order to reduce the impact of external humidity. Moreover, in a case where the fogging phenomenon occurs on the lenses, the heat supply unit HL may compensate for insufficient heat when the fogging phenomenon is not removed sufficiently by the heat dissipation unit HD.

Moreover, the heat supply unit HL and the heat dissipation unit HD may be arranged to be spaced apart from each other. Accordingly, the impact of heat generated by the heat supply unit HL on the heat dissipation unit HD can be minimized. That is, the heat dissipation unit HD may efficiently dissipate heat by the light source and the substrate instead of the heat generated by the heat supply unit HL.

For example, although the heat supply unit and the heat dissipation unit HD are spaced apart from each other, they may extend in parallel within the frame. Accordingly, the fogging phenomenon can be more effectively inhibited from occurring.

Further with reference to FIGS. 45 and 46, as described above, the heat supply unit HL may be positioned within the frame 100. That is, like the heat dissipation unit HD, the heat supply unit HL within the frame 100 may surround the edge of the lens GL. Accordingly, the fogging or similar phenomenon can be more effectively inhibited.

The heat supply unit HL may also be electrically connected to the optical device 200. Moreover, the heat supply unit HL may be electrically connected to the controller or the control unit within the electronic device. Alternatively, the heat supply unit HL may be electrically connected to the controller or the control unit within the optical device.

The heat dissipation unit HD and the heat supply unit HL may be sealed with the sealing member (for example, epoxy) in order to reduce the impact of external humidity. Moreover, in a case where the fogging phenomenon occurs on the lenses, the heat supply unit HL may compensate for insufficient heat when the fogging phenomenon is not removed sufficiently by the heat dissipation unit HD.

Moreover, the heat supply unit HL and the heat dissipation unit HD may be arranged to be spaced apart from each other. Accordingly, the impact of heat generated by the heat supply unit HL on the heat dissipation unit HD can be minimized.

In the present embodiment, the frame 100 may include an upper region US and a lower region BS. The lens GL may be divided into two halves relative to the upper region US and the lower region BS. At this point, either the heat dissipation unit HD or the heat supply unit HL may be arranged in either the upper region US or the lower region BS. The remaining unit may be arranged in the other region. For example, the heat dissipation unit HD may be positioned in the upper region US. The heat supply unit HL may be positioned in the lower region BS.

In addition, as a modification example, the heat dissipation unit HD may be arranged within the frame 100 in such a manner as to surround the lens GL along the edge of the lens GL, and the heat supply unit HL may be positioned within one region of the frame 100. Accordingly, in order to effectively remove the fogging phenomenon, the heat supply unit HL may be positioned relatively predominantly in the lower region or the upper region.

With this configuration, energy efficiency can be achieved, and the fogging phenomenon can be effectively suppressed.

The method of operation according to the disclosed embodiment may be implemented in the form of program commands executable by various computer apparatuses and thus be recorded on a computer-readable medium. In addition, the embodiment of the present disclosure may be a computer-readable recording medium on which one or more programs containing commands executing the method of operation.

A program command, a data file, a data structure, and the like are recorded individually or in combination on the computer-readable medium. Program commands that are recorded on the medium may be ones that are specially designed and configured for the present invention or are publicly known and available to a person of ordinary skill in the computer software field. Examples of computer-readable recording medium include magnetic media, such as a hard disk, a floppy disk, and a magnetic tape, optical recording media, such as a CD-ROM and a DVD drive, magnetic-optical media, such as a floptical disk, and hardware devices, such as a ROM, a RAM, and a flash memory, that are specially configured to store program commands to be executed. Examples of the program commands include machine language codes, such as those generated by a compiler, and high-level language codes executable by a computer using an interpreter or similar tools.

The computer-readable storage medium may be provided in the form of a non-transitory storage medium. The ‘non-transitory storage medium’ refers to a tangible medium that does not include signals (for example, electromagnetic waves). This term is used indistinctly to refer to a storage medium on which data are stored semipermanently and a storage medium on which data are stored temporarily. For example, the ‘non-transitory storage medium’ may include a buffer in which data are stored temporarily.

As an example, the methods of operation according to various embodiments described in the present specification may be provided in the form of a computer program product. The computer program products may be sold as commercial products. The computer program products may be distributed in the form of a computer-readable storage medium (for example, a compact disc read-only memory (CD-ROM)) or be distributed online (for example, downloaded or uploaded) through application stores (for example Play Store™) or between two user devices (for example, smartphones). In the case of online distribution, at least one portion of the computer program product (for example, a downloadable application) may be at least temporarily stored or transiently generated in computer-readable storage media, such as memories, in servers located at manufacturing companies, servers located at application stores, or relay servers.

Specifically, at least one portion of the computer program product may be realized in the form of a computer program product including a recording medium on which a program for executing the method of operation according to the disclosed embodiment.

The embodiments are described in detail above, but impose no limitation on the claimed scope of the present invention. Various modifications and improvements that a person of ordinary skill in the art makes using the fundamental concept of the present invention that is defined in the following claims are also included in the claimed scope of the present invention.

The term “unit,” which constitutes the name of each of the constituent elements described in the present embodiments, refers to a software constituent element or a hardware constituent element, such as a field-programmable gate array (FPGA) or an ASIC, and performs a certain function. However, the term “unit” is not limited to a software constituent element or a hardware constituent element. The constituent element whose name includes the term “unit” may also be configured to reside in an addressable storage medium and may also be configured to enable one or more processors to perform processing. Therefore, examples of the constituent elements whose names include the term “unit” include constituent elements, such as software constituent elements, object-oriented software constituent elements, class constituent elements, and task constituent elements, processes, functions, attributes, procedures, subroutines, program code segments, drivers, firmware, microcodes, circuits, data, databases, data structures, tables, arrays, and variables. A number of the constituent elements may be functionally combined into a smaller number of constituent elements, and the constituent element may be further functionally divided into additional constituent elements. A number of the constituent elements whose names include the term “unit” may be functionally combined into a smaller number of constituent elements whose names include the term “unit,” and the constituent element whose name includes the term “unit” may be further functionally divided into additional constituent elements whose names include the term “unit.” Moreover, the constituent elements or the constituent elements whose names include the term “unit” may also be realized in such a manner as to enable one or more CPUs within a device or a security multimedia card to perform processing.

The present invention is described above with a focus on the embodiments thereof, but is not limited to these embodiments. It would be apparent to a person of ordinary skill in the art to which the present invention pertains that various modifications to and applications of these embodiments are possible within the range that does not depart from the essential features thereof. For example, each constituent element specifically employed in the embodiments can be realized in a modified manner. Differences related to these modifications and applications should be interpreted as falling within the scope of the present invention, as defined by the following claims.

1. An optical device comprising:
a plurality of lenses;
a barrel in which the plurality of lenses are arranged;
a first light guide arranged in the barrel;
an opening portion formed in a lateral surface of the barrel;
a light source device coupled to the opening portion;
a through-hole formed in the lateral surface of the barrel; and
a light reception unit arranged adjacent to the through-hole.

2. The optical device of claim 1, comprising:
a barrier unit arranged between the through-hole and the light reception unit.

3. The optical device of claim 1, comprising:
an optical signal generation unit configured to generate an optical signal including an image signal,
wherein the light receiving unit is arranged between the first light guide and the optical signal generation unit.

4. The optical device of claim 3, wherein the plurality of lenses include a first lens and a second lens that are arranged between the first light guide and the optical signal generation unit, and the first lens has a smaller size than the second lens.

5. The optical device of claim 4, wherein the light reception unit is arranged between the first lens and the second lens.

6. The optical device of claim 4, wherein the through-hole is arranged between the first lens and the second lens.

7. The optical device of claim 1, wherein the light reception unit protrudes farther than the external surface of the barrel.

8. The optical device of claim 2, wherein the barrier unit protrudes farther than the external surface of the barrel.

9. The optical device of claim 1, comprising:
a housing in which an opening portion is formed;
a second light guide arranged in the housing; and
a light source configured to emit light toward the second light guide.

10. The optical device of claim 9, wherein the light reception unit is driven while light is emitted from the light source.
